(19) United States
(12) Patent Application Publication
(10) Pub. No.: US 2007/0130044 A1
(43) Pub. Date: Jun. 7, 2007

(54) Transaction management system and method

(75) Inventor: Nicholas David Wingham Rowan, London (GB)

Correspondence Address: BROOKS KUSHMAN P.C., 1000 TOWN CENTER, TWENTY-SECOND FLOOR, SOUTHFIELD, MI, 48075, US

(73) Assignee: GUARANTEED MARKETS LTD, London (GB)

(21) Appl. No.: 10/595,873

(22) PCT Filed: Nov. 11, 2004
(86) PCT No.: PCT/GB04/04756

§ 371 Date: May 17, 2006

(30) Foreign Application Priority Data
Nov. 19, 2003 (GB) 0326895.0

(51) Int. Cl. G06Q 40/00

(52) U.S. Cl. 705/37

(57) ABSTRACT

An electronic transaction management system has at least some sellers associated with agencies. Information is provided for each agency to indicate whether the agency is prepared to offer sellers associated with the agency to buyers associated with other agencies and the terms of any such offer. A buyer interface is used to receive a purchase inquiry from a buyer, and seller offer data is provided to the buyer for a plurality of sellers. The seller offer data presented to the buyer takes into account the terms of said offer of sellers associated with an agency to buyers associated with other agencies. This system allows middlemen to operate in an online spot market. This is achieved by enabling agencies in a market sector to present their buyers and sellers with the agency's own version of such a market but draw on the buyer/seller relationships enjoyed by other agencies using the system. Agencies can operate their own market which is a distinct part of a wider market.

### FIELD OF THE INVENTION

The present invention relates to the field of online commerce. In particular it relates to the operation of electronic markets in which there are a plurality of both sellers and buyers.

### BACKGROUND OF THE INVENTION

In respect of buying and selling online, each transaction is conducted through one of a variety of mechanisms for matching the buyer and seller. These mechanisms include online catalogues, auctions. bid/ask systems, buyer aggregation, request-for-quote services and bulletin board listings. Each mechanism is strong for certain types of transaction and weak for others.

The mechanisms above can be divided between those that allow immediate purchasing of pre-determined goods or services and those that accommodate irregular purchase requests but require more time for a purchase to complete.

An online catalogue of the type accessed at Amazon.com for example allows goods that have been described by the seller to be displayed to buyers at a price set by the seller. Similarly items auctioned on sites such as ebay.com are described by the seller but he then waits to see what price the market will pay for his offering.

Bid/ask services such as that operated by Priceline.com and described in U.S. Pat. No. 5,794,207 require buyers to define a specific item or range of items to be purchased, typically an airline ticket between two points in a given date range, then wait to see if that need will be matched from a seller's database of pre-described offerings.

By contrast a buyer accessing a request-for-quote service such as that operated by guru.com is able to define his particular needs of the moment, a day of web design work at a specified location for instance, and then receive quotes from sellers who, having digested his requirements, quote a price at which they are willing to fulfil his need. This is time consuming for all concerned. Buyers must wait for a range of sellers to reply to their request to be sure they are paying a market price. Sellers must take the time to understand buyers' requirements and bid, knowing they may not be successful in getting the business.

The time consuming nature of online transactions in which the buyer is able to define his exact needs rather than shopping between various options pre-defined by sellers makes existing mechanisms impracticable for many transactions. They include short notice purchases or small purchases where the sum involved does not merit the attention of sellers or the waiting of buyers.

Ideally, in many markets, a buyer would wish to define his exact requirements of the moment and immediately be given a list of sellers specifically available and ready to meet that need. For instance his need might be “I want a temporary secretary to work from 2.00 to 6.00 this afternoon at my office”. He would then wish to see an immediate list of sellers who were (a) qualified to work as secretaries (b) in the vicinity of his office (c) willing to work this afternoon (d) currently willing to accept assignments at short notice (e) currently willing to accept assignments of only a few hours duration (f) could be contacted in time to receive details of this period of work.

Existing mechanisms are of little use to such a buyer. A bulletin board for instance will reveal a list of possible secretaries who can be emailed to see if they meet the characteristics above. An auction would be too time consuming for the buyer who could more easily phone a temporary worker supply agency. An online catalogue that simply allows the buyer to browse a list of offerings is again too time consuming for this buyer. Bid/ask type services require the buyer to input the price he will pay rather than allowing a market rate to be established.

To overcome this gap in the art the present inventor has previously disclosed elements of an online buyer/seller matching system called “GEMs”. Such a system is defined by an ability to take in a buyer's requirements and immediately construct options specific to his needs based on broader inputs from any number of sellers. Any of these options can then be purchased immediately. Such a system could run a plurality of markets in different sectors, for example purposes such markets might include: bicycle hire, hire of a driving instructor or short notice office cleaning services.

FIG. 1. shows the buyer input screen for such a system as completed by a buyer who is seeking to book a temporary secretary. FIG. 2 shows the options returned immediately by such a system. These are not bulletin board style listings showing potential sellers who may possibly be available and possibly be interested in this transaction. They are specific options built around the buyer's inputs, priced and ready for purchase.

Such a system holds considerable information about each seller which can be searched in the light of a specific buyer's enquiry. Each seller displayed on the screen represented at FIG. 2 has previously specified parameters within which they are willing to sell. These may include geographical area, period-of-notice for an assignment and length of assignment. This information is stored. All of those parameters are met by this requirement for each seller on the screen. The system has also checked that the seller is showing availability in an online availability diary this afternoon and that their diary of times when they undertake to be reached, for instance by mobile phone text message or email, would allow them to be notified or this transaction in time. The buyer can choose any one of these sellers and the system will inform the individual of the assignment will regarding them as sold and making the required amendments to their availability diary.

Aspects of the GEMs invention have been disclosed in publications by the present inventor. An overview of one embodiment of such a system will now be provided to illustrate one form of underlying architecture for the present invention. Referring first to FIG. 3, this shows a generalised embodiment 300 of a system that might underlie the present invention. Such a system might run a number of markets in different sectors, examples of sectors include: secretarial services, office rental and specialist facility hire.

A communications network 303 is connected to seller terminals 301a and b and buyer terminals 302a and b and to a system communications interface 304. The communications network may comprise any conventional communications network such as a telephone network or the Internet. The communications interface couples the buyer and seller terminals to the system communications interface 304 to provide user interfaces to the system to allow buyers and sellers to request and execute transactions using the system.

The communications interface 304 is coupled to a communications processor 305 which creates screens and messages for communicating with buyer and seller terminals 302 and 301. The communications processor is connected to an Application processor 306 for providing transaction management applications. Application processor 306 is also coupled to a system service provider terminal 308 to allow a system service provider/operator direct access to aspects of the system to which access via communications network 303 is restricted for security reasons. Thus service provider terminal 308 may be used for system management, account management, program code updating, setting a mark-up on each transaction within the system for operator revenue purposes and similar functions. In an alternative embodiment service provider terminal 308 may be connected through a wider communications medium such as the Internet.

Application processor 306 is coupled to data store 307 storing system-related data. It is also able to communicate with external servers that perform specific additional tasks for the benefit of system users.

Thus Application processor 306 can process data for output to buyer and seller terminals 302 and 301 and communications processor 307 can access the data to send and receive messages to and from terminals 302 and 301. Thus data in data store 307 is indirectly accessible via buyer and seller terminals 302 and 301.

The communications interface 304, communications processor 305, the Application processor 306 and the data store 307 may all be provided within a single general purpose computer or these functions may be distributed over a plurality of machines in a manner well known to those skilled in the art.

The communications network 303 in this embodiment is the Internet to which are coupled buyer terminals 302a and b and seller terminals 301a and b. Also coupled to Internet 303 is a gateway (not shown) to a mobile phone network 309 (or, more generally, any mobile communications network) which communicates with a mobile station 311, such as a phone handset, using base transceiver station 310.

FIG. 4. illustrates a preferred embodiment for the system's architecture within a central server. Communications processor 305 interacts with communications interface 304 to receive inputs and forward output communications to buyers and sellers. Application server 306 contains software modules allowing new users accessing the system through the communications network to register as sellers 421 or buyers 422, or both. Transaction management module 423 extracts market rules information from the data store to govern information displayed to users in a particular market and the prioritization of searches. Assembly of options module 424 searches for a buyer's requirements applying appropriate filtering. In its simplest embodiment this module sends all sellers returned by the search to the communications processor 305. Price Construction Module 425 takes the list of sellers produced by Assembly of Options Module 424 and constructs the unit price at which each seller will fulfill this buyer's specified needs.

Once a buyer has selected a seller he wishes to purchase, post sale management module 426 compiles the information about the buyer and transaction that is required to inform the seller of all required details of the sale. Payment transfer module 427 ensures value is transferred from buyer to seller according to instructions in the market rules data store. This might involve credit card processing, transfer of digital value, holding sums in escrow or raising of an online invoice. It may entail breaking the transaction down into parts, the completion of each triggering part payment. Typically this could be achieved by means of a timesheet signed by buyer and seller using their system passwords at the end of each week of a booking. All these processes will be familiar to one skilled in the art and can be performed by widely available software.

User maintenance module 428 applies rules to the seller and buyer data store as instructed through the service provider terminal 308. These might include for instance generating email to any user who has not been active in the last 6 months asking that they confirm the email address, and therefore their identity. is still valid.

The data store 307 comprises firstly a database of sellers 431. For each seller this includes unique identifying code, name, password, date of birth, contact details, time and date of registration, unit price to be charged to buyers, history of transactions performed plus earnings and details of how payments are to be transferred. For each seller there is additional data stored which can be changed at any time by the seller to which it pertains. Selling parameters record 431a stores that seller's preferences for sales, for instance how far from their base travel code they are willing to travel. Seller availability record 431b stores data input by the seller about the times when they are available to be sold by the system. Seller contactability record 431c stores data of the times the seller undertakes to be available for contact by the system and the means by which messages should be sent.

Buyer database 432 includes information about each buyer on the system. This includes unique identifying code, name, administrator password, headquarters address, time and date of registration, details of other users within the buyer's account allowed to buy on its behalf (named members of staff for example), how payments are to be collected, history of transactions and payments made and the information to be displayed to sellers, for instance showing locations of the buyer's buildings at which they may be required to work.

Transaction database 433 records details of all transactions on the system. A preferred embodiment of this database includes the following record of any purchase or partly completed purchase: unique identifying code, market in which purchase was made, identity of buyer, identity of seller, time purchase initiated, number of units bought (hours of work for instance), dates units were to be supplied, times of day units were to be supplied, price paid per unit, selling parameters pertaining to this transaction and current status of the transaction which can be only one of the following exemplary list: waiting for seller confirmation/not confirmed/confirmed/in progress/cancelled/completed.

Market rules database 434 stores information pertaining to each market sector. Wording and options required to make up screens or messages for the user are extracted by communications processor 304. Market rules database 434 also stores rules on admission to a market, for instance “only sellers over 18 permitted” or “no more than 50 hours to be sold by any individual seller in one 7 day period”.

In the above-described aspects of the invention communication between the system operator or intermediary and/or buyer and/or seller may be by any convenient communication means, but the invention is particularly suited to implementation using an electronic communications network such as the Internet, and Intranet, or an Extranet, or wireless mobile communications.

In preferred embodiments the invention is implemented on general purpose computer systems using appropriate software. The software may comprise instructions in one or more of HTML, XML, Java, Perl or other programming languages. Thus aspects of the invention may be embodied in computer program code, either as separate applications or parts of a single program. As the skilled person will appreciate, such program may comprise source, object or executable code and code may be implemented on a single machine or shared between different hardware platforms. Such program code may be provided on any conventional carrier medium such as tape, disk, CD-ROM, programmed memory or on an electrical or optical signal carrier. The processor implementable instructions of the buyer and seller terminals may be stored on a network server and provided to the terminal as needed, for example as an Internet data page or web page.

Processes used in such a system will now be described. For ease of understanding the operation of the system will be described with reference to a specific example of the system's use, that of providing temporary secretaries to employers. However use of the system is not restricted to this application.

### Listing Goods or Services to be Sold

A new seller will typically enter the system through a portal accessed via the communications network 303 and constructed by the communications interface 304. This page is able to activate the seller registration module 421. Having taken details of the individual or company, this module then offers a selection of markets in which anyone might register to sell. Thus a new seller might be asked “what do you wish to sell” and then offered a first selection list which includes “my time”. This response prompts a second list from which she chooses “formal temporary work” and then “secretarial work”. A seller can choose to sell in multiple market sectors. A seller may not be named as an individual but simply as “secretary from XYZ Agency”. They are then invited to input the pricing data that allows their price for a transaction for which they are applicable to be constructed. In its simplest embodiment this requires only that they specify a flat-rate price for each unit of sale or part thereof. In the temporary work market the unit of sale is hours.

Thus the system knows the individual's name, contact details, including email address and optional mobile phone number, and that she wishes to sell her time as a temporary secretary at, for example, $8.35 an hour. These details are recorded in seller database 431.

At this point the seller registration module 421 asks the questions that allow this user's parameters for any potential sale to be stored in the seller parameter record 431a. A list of parameters relevant to sales in the secretarial market are accessed from the market rules database 434. They may include:
Geography (for example: “My home postal code is X and I will not work more than Y miles from that point”)
Size of purchase (for example: “I will not accept bookings of less than 4 hours” or “I will not accept bookings lasting more than 10 working days”)
Period of notice for purchase (for example: “I only accept bookings where I have at least 24 hours notice of the job”)

Additionally the seller may be able to define specific buyers registered on the buyer database 432 with whom they are unwilling to trade. This is recorded on the seller parameter record 431a.

The new seller is then offered a blank diary of time blocks, possibly in half hour increments, covering each day for the remainder of the current week. She can click through to further pages covering following weeks. By selecting certain blocks she is able to select the precise times when she is available to work. This is stored in the seller availability diary 431b. By default this diary remains blank with no availability until the seller has input details of her willingness to work.

In a further embodiment the seller is now presented with a second set of diary pages and asked to input times when she undertakes to be contactable by the system. These are periods when she will be logged on to receive email or will have her mobile phone switched on and about her person to receive text messages. This data is stored in the seller contactability record 431c.

Thus it will be clear that the seller database 431 now holds details of the individual's identity (including password), market or markets in which they wish to sell, their unit price, the constraints on any sale they will accept, the times they are available to sell their chosen goods or services sold by the system and the times at which they can be contacted by the system. Any part of this information can be changed at any time by the seller logging on and triggering the user maintenance module 427. This will display current choices stored in the seller's parameter record 431a, availability diary 431b and contactability record 431c. The seller can then choose to overwrite her current preferences.

The above example pertains to a potential seller wishing to sell their time. It will be clear the architecture described could equally accept listings for other services. For example: vehicle hire, domestic storage capacity, sales of organic produce or childcare. In each case the market rules database 434 would provide a list of relevant parameters to be completed by the seller. An example of the selling parameters by which sellers can define their willingness to sell based on a buyer's specific needs for some further markets will now be given.

| | UNIT | |
|---|---|---|
| | OF | |
| MARKET | SALE | SELLING PARAMETERS |
| Overnight | Night | Length of stay/time of arrival/time of departure/ |
| accommo- | | number of people in room/smoker or non- |
| dation | | smoker/period of notice before accommodation |
| | | required |
| Hire of | Hour | Distance to buyer/anticipated hours of work |
| agricul- | | within the hire/length of hire/period of notice |
| tural | | to hire |
| tractors | | |
| Local | Mile | Period of notice to pick up/distance from seller |
| deliveries | | postalcode to pick up point/length of journey/ |
| | | distance from seller postalcode to drop-off point/ |
| | | weight of object to be delivered/size of object to |
| | | be delivered |
| Industrial | Cubic | Time of drop-off/time of collection/shortness |
| storage | metre | of hire/length of hire/period of notice/type of |
| space | | commodity being stored/value of goods stored |
| Specially | Kilo | Smallness of cake/largeness of cake/style of |
| commis- | | cake (selected from drop down boxes)/period of |
| sioned | | notice before delivery/delivery method/ |
| home cake | | additional trimmings (selected from drop down |
| baking | | boxes) |

### The Purchase Process

A new buyer accesses the system through communications interface 304 and is shown a generic welcome page generated by communications processor 305. From this the new buyer is able to trigger buyer registration module 422. This sends pages requesting information, validates that information and uses it to populate a record in buyer database 432. Confirmation of the buyer's means to pay may be obtained through a link to an external agency such as a credit card supplier using communications network 303 before purchasing is allowed. This process is well known to those in the art.

A buyer wishing, and permitted, to make a purchase can trigger the transaction management module 423. This will offer a page such as that shown in FIG. 1. that establishes the Following. (a) What he wishes to purchase (for example: the time of a temporary secretary) This information is sent to the market rules database 434 which provides the parameters which must be defined to enable a search of the seller database 431. (b) The quantity he wishes to purchase (for example by defining a period of daily hours which the system can multiply by the number of days input at the next step). (c) The times he wishes to purchase (for example: by defining a start and end date for a booking). (d) The geography in which he wishes the purchase to be realized (for example: place of work is postalcode Y).

Transaction management module 423 will ensure all required information is in place before beginning a search. Once the required inputs have been completed the transaction management module creates a record on the transaction database 433. A unique identifier code for this transaction is established at the time of storage. The transaction management module 423 then initiates a search of the seller database 431 based on the buyer inputs. The search is performed by assembly of options module 424. It excludes those sellers who are among any of the following. (a) Not selling the services/goods the buyer wishes to purchase. (b) Not willing to sell in the area defined by the buyer. (c) Not willing to sell the number of units (for example hours) demanded by the buyer. (d) Not willing to sell with the period of notice For this transaction. (e) Not available at the dates and times the buyer requires. (f) Not contactable in the time required before the purchase.

Thus the assembly of options module 424 is able to return a list of any sellers on the database who meet the following conditions. (a) Selling the services or goods required by the buyer. (b) Willing to sell in the geography required. (c) Willing to sell with the period of notice specific to this job. (d) Available for the times and dates required. (e) Contactable in time for this booking.

This list is sent to price construction module 425. This could factor in multiple considerations as it constructs the price for each seller. In it simplest embodiment, this module looks up the unit price for each seller on the list, such data being held in seller database 431 and multiplies it by the number of units for this sale. Alternatively it may use the selling parameters of the present requirement as outlined in exemplary form in the screen shown in FIG. 1, coupled with a list of pricing preferences from each user, to construct a specific price for this one transaction for each seller. It may also add a mark-up input by the system operator through service provider terminal 308. This provides revenue for the market operator and is retained during any subsequent transfer of payment between buyer and seller. Alternatively the market operator might invoice either party for its transaction fee at a future date.

This list of options and their prices is stored in the transaction database 433 against the unique identifier for this query. If no sellers are returned the transaction management module 423 creates a message for the buyer suggesting a change of requirements.

The list of sellers and prices thus stored are now sent by the communications processor 304 and the communications interface 304 to the buyer terminal 302. Before doing so assembly of options module 424 may apply rules such as “display in price order from left to right putting identically priced sellers in alphabetical order” or “only display a maximum of 20 sellers on one screen”. Such rules would be input from service provider terminal 308.

One embodiment of such a page is represented in FIG. 2. If the buyer selects “purchase” on any option or options presented to him, that information is stored in the transaction database 433. A page of information for the seller has to be completed by the buyer and payment is arranged according to instructions in the market rules database 434 by payment transfer module 427. This module will access proprietary software well known to those in the art such as credit card approval, transfer of digital value between users on the system or invoice generation and return a “payment OK” flag to be recorded on Transaction Database 433.

Once payment arrangements have been confirmed the post sale management module 426 is triggered. This performs the following tasks. (a) Confirms the seller is still available. If they have removed their availability or been bought by another conflicting buyer since the search showed them to be available the buyer might be advised with a message. (b) Removes the appropriate availability from the seller's record in the seller database 431. (c) Creates a message for the chosen seller revealing the buyer's identity stored in buyer database 432 and adding details of his purchase from the transaction database 432. In a temporary work transaction these would include: place of work, hours of work, days to be worked and information input by the buyer to be passed to the seller. (d) Looks up contact details on the seller database 431 and directs the message to email or mobile phone for instance via the communications processor 304. (e) Monitors that the seller confirms they will undertake the assignment before the start of work time. If they do not a message might be generated for the buyer advising that the seller has not confirmed and the buyer may wish to re-book. (f) Triggers release of payment. This could be from escrow funds at a specified point based on rules in the market rules database 434 (for example 48 hours after completion of the transaction). In a temporary work market this would be likely to be based on completed timesheets each of which triggers an invoice rather than online value transfer. Online timesheets may be based on technology such as Web Timesheet from Adeo Software or the Time product from Artologik Software

It will be appreciated that modules listed above could be combined in practice. Their listing is purely illustrative of the functions to be performed and is not intended to define the system's structure.

### Benefits of the System

This is a “spot market” online based on a user's exact requirements at the time of purchase. Existing systems for buyer/seller matching do not allow immediate purchasing from an infinite number of sellers who may have entered the market with broad ranging availability to sell only seconds earlier. Online bulletin boards offer listings of sellers who may be available for a general need. Internet auctions require time consuming bidding. Using bid/ask systems the buyer must define parameters of the potential purchase which has to be matched by a precise offering defined by the seller.

“GEMs” type markets such as that just described provide a list of named sellers any one of whom can be booked immediately for a buyer's specific requirements. Unlike online catalogues these markets are able to construct a specific offering for a buyer's needs based on much more general inputs by a plurality of potential sellers.

There are potential enhancements to a system as described above that are already in the public domain:

For example, in a “grading of sellers” embodiment, user maintenance module 428 promotes sellers up a ladder of grades as they complete specified numbers of trades. Buyers can view relevant sellers produced by the search listed by their grades in the market. Grading data is stored on the seller database 431. Users may move automatically through grades as the user maintenance module 427 periodically sweeps the seller database checking number of units sold in each market.

WIPO patent application WO 02/091100 discloses a GEMs system of this type in more detail, and discloses a system that allows sellers to be graded and that economically underwrites transactions by certain sellers. This document also explains how the operator of the system gains financially from maintaining the system, and also discloses a system of compensation for buyers where a seller defaults. This document is incorporated herein by way of reference material.

Electronic markets often suffer from their lack of human interaction. With only a website on offer there is nobody to encourage sign-up, be on hand when problems emerge or provide a point of ongoing contact for users. Additionally electronic markets often stand outside existing structures of middlemen and business relationships and so fail to make inroads. Alternatively each middleman in a sector sets up their own market between their buyers and sellers. This is inefficient as choice and competitiveness are increased if buyers are able to interact with the maximum number of sellers and vice versa. A drawback to the spot market system as described above is thus the lack of incentive for existing middlemen in a market to join such a system or further its development.

It is known that online service such as those available at www.bridgepath.com and www.subcontract.com provide a forum by which agencies can find other agencies with whom they wish to do business. However, such services provide only listings of broadly suitable candidates. Thus an Agency with a seller who needs a buyer can advertise or search existing listings in the hope of finding an agency with a buyer but no seller. But the deal requires telephone or email dialogue before a purchase.

### SUMMARY OF THE INVENTION

According to a first aspect of the invention, there is provided a transaction management system for managing the purchase of an item and/or service by a buyer from a seller, wherein at least some sellers are associated with agencies, the system comprising:
a plurality of agency data stores, each for storing agency data comprising:
   seller data for each of a plurality of sellers associated with the agency; and
   indication data for indicating whether the agency is prepared to offer sellers associated with the agency to buyers associated with other agencies and the terms of any such offer;
      a program store storing processor implementable instructions; and
a processor coupled to the agency data store and to the program store for implementing the stored instructions; wherein the stored instructions comprise instructions for controlling the processor to:
implement a buyer interface to receive a purchase inquiry from a buyer;
output seller offer data to the buyer for a plurality of sellers, wherein the seller offer data presented to the buyer takes into account the terms of said offer of sellers associated with an agency to buyers associated with other agencies;
receive a purchase request from the buyer accepting a said offer; and
implement a seller interface to output the purchase request to the identified seller for requesting purchase of a service or item; and ascertain compliance data for determining whether the identified seller is willing or able to comply with the buyer purchase request.

The present invention relates to a means of allowing middlemen to operate in an online spot market. This is achieved by enabling agencies in a market sector to present their buyers and sellers with the agency's own version of such a market but draw on the buyer/seller relationships enjoyed by other agencies using the system. For example, if Agency A is unable to fulfill one of their buyer's requirements they would be able to draw on sellers put into the online market system by Agency B, C, D, E and so on. Similarly if Agency A had more sellers than buyers those sellers could be made available to other agencies' buyers.

Such arrangements typically exist in many industries offline either in the form of informal agreements in which the rate is negotiated for each sale or embedded in formal “master vendor” relationships in which one agency agrees a rate at which it will sell to another. In such cases the agency providing the goods or services to be sold is known as the “sub vendor” or “provider” and the agency re-selling them to its buyer as the “master vendor” or “re-seller”.

The present invention allows agencies to operate their own market which is a distinct part or a wider market. They can draw on the wider market in a highly fluid way as required to meet the needs of their clients enabling business processes that are not currently viable. Using the present invention, the smallest agency is able to serve the largest client using instantly assembled sub vendors. Likewise an agency with no clients is able to enter hundreds of newly signed up sellers immediately into the market. This increases competition among agencies creating better standards of service to buyers and sellers.

All agencies using the system will be incentivized to encourage sign up to the electronic market in their geographic locality and to transfer existing buyers and sellers to the electronic market. Additionally they can maintain the character of their operation: focusing on a particular kind of seller for instance and forming instant networks for transactions with other agencies they regard as comparable. This is likely to prompt a degree of localized and motivated customer care with accompanying quality control that is rarely available to users of large online markets. Additionally agencies will be able to set the boundaries of master vendor agreements constructed instantly as required for immediate individual purchases while maximizing sales of their own sellers. Thus, competition between agencies to supply to other agencies becomes transparent and is encouraged.

The invention allows the deals between agencies to be constructed and priced instantly and offered for immediate sale according to the precise needs of a buyer and the priorities of each agency.

The system may operate by having a number of agency data stores which can communicate with each other. Preferably, however, a general data store is provided for storing seller data comprising, for each of a plurality of sellers not associated with any agency, a seller identifier and seller offer data indicating at least one service or item of commerce offered for sale.

This general data store is also preferably used for storing seller data comprising, for each of a plurality of sellers associated with an agency, a seller identifier, seller offer data indicating at least one service or item of commerce offered for sale, and data indicating the agency with which the seller is associated. Thus, all seller data is stored centrally. Buyer data may also be stored centrally, identifying, for each of a plurality of buyers associated with an agency, data indicating the agency with which the buyer is associated.

The seller data in the general data store may further comprise an availability diary for the seller, and historical data relating to the previous seller performance in response to purchase requests associated with the seller. This information enables the ability of the seller to provide the goods or services to be guaranteed by the system administrator. The system is therefore transactional, in that no reference to the seller is required until the transaction has been concluded. In particular, the output seller offer data is presented to the buyer, and the acceptance of a purchase request is received from the buyer without reference to the seller.

The stored instructions preferably comprise instructions for controlling the processor to:
output seller offer data from the agency with which the buyer is associated; and
output seller offer data from other agencies when the agency with which the buyer is associated accepts the terms of the offer of seller from the other agencies.

A list is thus generated, and the sellers of the agency with which the buyer is associated can be prioritised. The acceptance between agencies can for example be based on the mark-up, geography and/or market sector of the other agencies.

The stored instructions may comprise instructions for controlling the processor to output seller offer data from other agencies only when insufficient offers are available from the agency with which the buyer is associated. Thus, if the buyer agency cannot source enough sellers, it can then resort to other agencies (and it may receive less commission from these sellers).

The seller offer data can be presented in an order based on factors including a ranking given to the other agencies, for example determined by negotiation between agencies and which can be amended by negotiation between agencies.

The seller offer data preferably includes a price for the buyer which takes into account all agency fees. In one implementation, the price is obtained by adding to the seller price, the agreed commission corresponding to the offer from the agency with which the seller is associated to the agency with which the buyer is associated, and the commission of the agency with which the buyer is associated. This will result in a higher price to the buyer.

An alternative therefore is to add to the seller price only the commission of the agency with which the buyer is associated, a part of this commission being paid to the agency with which the seller is associated under the terms of the offer from the agency with which the seller is associated to the agency with which the buyer is associated. In this case, the price to the buyer is not affected by the fact that the supplier has come through another agency. However, this can result in a negative commission to the buyer agency.

Preferably, therefore, the system can determine if the commission to be paid to the agency with which the seller is associated is greater than commission of the agency with which the buyer is associated, and if so the offer is removed from the seller offer data.

A software module may be provided for automatic acceptance of terms under which sellers associated with one agency are offered to buyers associated with the other agency, when these terms meet predetermined criteria. For example, one agency can accept the offer of sellers from another agency when given geographical and mark-up conditions meet preset rules.

The agency data store may further comprise data indicating other agencies with which a seller has previously been associated. This enables a seller to transfer between agencies, and for the transfer of commission payments to be staggered over time. In particular, there are significant set up costs in placing a seller onto the system through an agency. If the seller transfers to another agency very quickly, the system can allow the original agency to continue to benefit for a time period. Thus, means is provided for determining payments between agencies when a seller transfers between the agencies.

A buyer or a seller can be associated with a plurality of agencies, and the agency data store then further comprises data indicating other agencies with which a buyer or seller is currently associated. The division of commission payments between agencies with which a buyer or a seller is associated is then determined by the system.

The agency data store can further comprise data relating to agreements between three or more agencies in which one agency acts as intermediary between two others.

The invention also provides a method for managing the purchase of an item and/or service by a buyer from a seller, wherein at least some sellers are associated with agencies, the method comprising:
storing in an agency data store seller data for each of a plurality of sellers associated with the agency, and indication data for indicating whether the agency is prepared to offer sellers associated with the agency to buyers associated with other agencies and the terms of any such offer;
implementing a buyer interface for receiving a purchase inquiry from a buyer;
outputting seller offer data to the buyer for a plurality of sellers, wherein the seller offer data presented to the buyer takes into account the terms of said offer of sellers associated with an agency to buyers associated with other agencies;
receiving a purchase request from the buyer accepting a said offer;
implementing a seller interface to output the purchase request to the identified seller For requesting purchase of a service or item; and
ascertaining compliance data for determining whether the identified seller is willing or able to comply with the buyer purchase request.

This is the method implemented by the system of the invention.

The invention also provides a buyer terminal for a buyer to remotely purchase a service or item from a seller via an intermediary system, the buyer being associated with an agency, the terminal comprising:
a data memory operable to store data to be processed;
a program store for storing processor implementable instructions;
a communications interface for receiving data from and transmitting data to the intermediary system; and
a processor, coupled to the data memory and to the program store for implementing the stored instructions, and to the communications interface for receiving and storing instructions for the processor in the program store;
and wherein, in use, the program store stores instructions for controlling the processor to:
   implement a buyer interface to receive a purchase inquiry from a buyer;
   receive seller data comprising, for each of a plurality of sellers, seller offer data indicating at least one service or item of commerce offered for sale relating to the purchase inquiry, the seller offer data presented to the buyer including sellers associated with other agencies and taking into account the terms under which said other agencies offer their sellers to the agency with which the buyer is associated;
   generate a user interface to output said seller offer data and to receive a purchase request from the buyer accepting a said offer; and
   transmit the purchase request to the intermediary system.

This terminal allows the method of the invention to be implemented.

The invention also provides a method for using a buyer terminal to remotely purchase a service or item from a seller via an intermediary system, the buyer being associated with an agency, the method comprising:
using the buyer terminal to make a purchase inquiry;
receiving seller data comprising, for each of a plurality of sellers, seller offer data indicating at least one service or item of commerce offered for sale relating to the purchase inquiry;
generating a user interface to output said seller offer data and receive a purchase request from the buyer accepting a said offer, the seller offer data presented to the buyer including sellers associated with other agencies and taking into account the terms under which said other agencies offer their sellers to the agency with which the buyer is associated; and
transmitting the purchase request to the intermediary system.

According to a second aspect of the invention, there is provided a method of supplying goods and/or services from a buyer to a seller via an intermediary, the method comprising:
logging details of goods/services on offer from a plurality of sellers;
recording which sellers are associated with agencies;
recording which buyers are associated with agencies;
recording which agencies are prepared to offer sellers associated with the agency to buyers associated with other agencies and the terms of any such offers;
receiving a purchase inquiry from a buyer;
presenting seller offer data to the buyer which takes into account the terms of any said offers, receiving a purchase request from the buyer accepting a said offer;
providing the purchase request to the identified seller; and
ascertaining compliance data for determining whether the identified seller is willing or able to comply with the buyer purchase request.

This method implements an agency system within an electronic transactional instantaneous market system. The seller offer data is preferably presented to the buyer, and the acceptance of a purchase request is received from the buyer without reference to the seller.

### BRIEF DESCRIPTION OF THE DRAWINGS

FIG. 1. shows a completed buyer input screen within a known online marketplace defined by an ability to take in a buyer's requirements and immediately construct options specific to his needs based on broader inputs from any number of sellers.

FIG. 2: illustrates an exemplary screen returned by such a marketplace in response to the buyer input in FIG. 1.

FIG. 3 is a schematic illustration of the communications links required for this known marketplace and which can form the basis of the system of the invention;

FIG. 4. represents the system architecture within the Application Processor 306 and Datastore 307 for the system of FIG. 3;

FIG. 5a. is a schematic illustration of the relationship between the agency server 500 in the system of the invention and the marketplace Application Processor 306 underlying marketplace 300

FIG. 5b. shows the applications and databases within the agency server 500

FIG. 6a. shows the table of basic information held about each agency in the agency datastore

FIG. 6b. shows an agency seller record within the agency datastore

FIG. 6c shows an agency buyer record within the agency datastore

FIG. 7. illustrates the screen showing Agency A which other agencies on the system might be willing to let Agency A display their sellers to Agency A's buyers and on what terms.

FIG. 8. represents the screen by which Agency A initiates negotiation with another agency about the terms on which they will allow display of their sellers by Agency A.

FIG. 9. shows the screen by which Agency A tracks their negotiations with agencies who may allow Agency A to display their sellers to Agency A's buyers

FIG. 10a. shows the screen by which Agency A can view and amend the prioritized list of agencies whose sellers may be displayed to Agency A's buyers

FIG. 10b illustrates a screen allowing users to change the prioritization of a selected agency on the screen represented in FIG. 10a

FIG. 11a and 11b. illustrate the search process triggered when a buyer owned by an agency inputs their requirements.

FIG. 12 shows an agency transaction record 565 within the agency datastore 545.

FIG. 13 illustrates a table of search results for inter-agency sales

FIG. 14. represents the screen showing Agency A other agencies on the system who might be willing to display Agency A's sellers to the other agency's buyers

FIG. 15. illustrates the screen by which Agency A can view and seek to amend their list of agencies on the system who are currently permitted to display Agency A's sellers to the other agency's buyers.

### DETAILED DESCRIPTION OF THE INVENTION

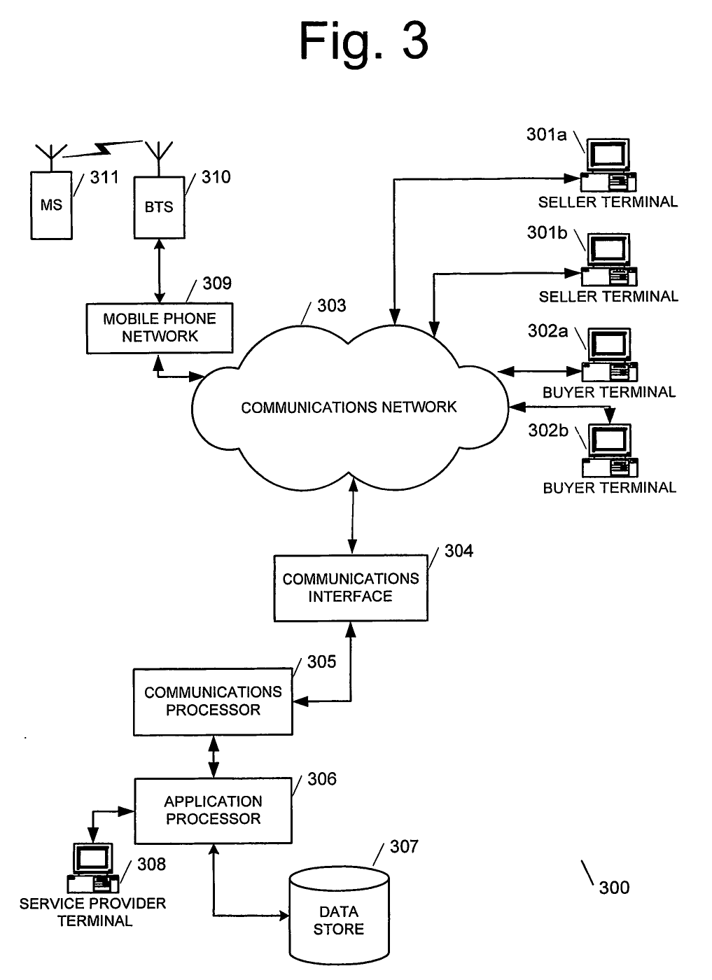

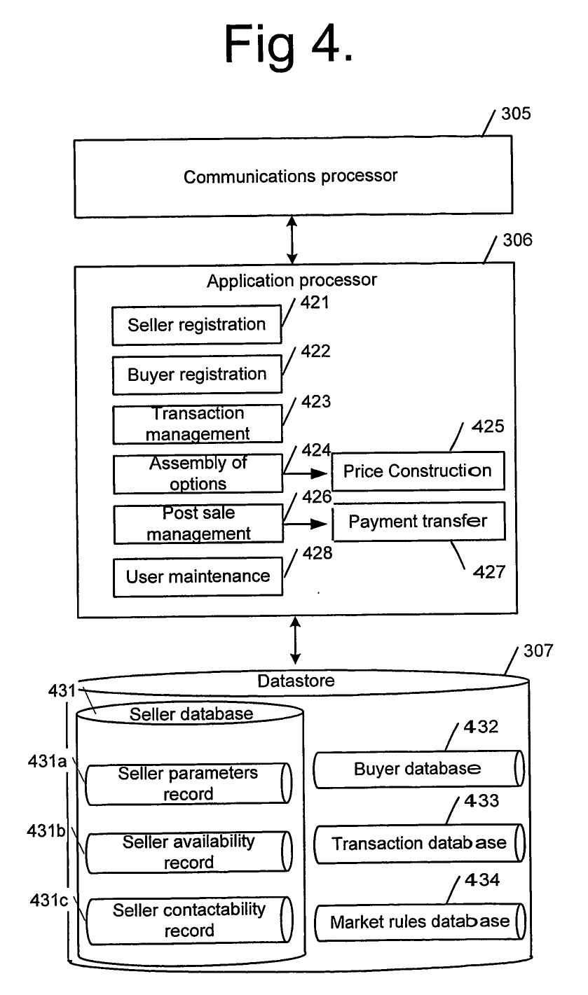

The present invention provides a set of software modules and a database that will work with an underlying market architecture which may be similar to that outlined in FIG. 3. and FIG. 4. The present invention allows for an existing marketplace to be supplemented by a plurality of agencies each having at least one buyer or at least one seller registered.

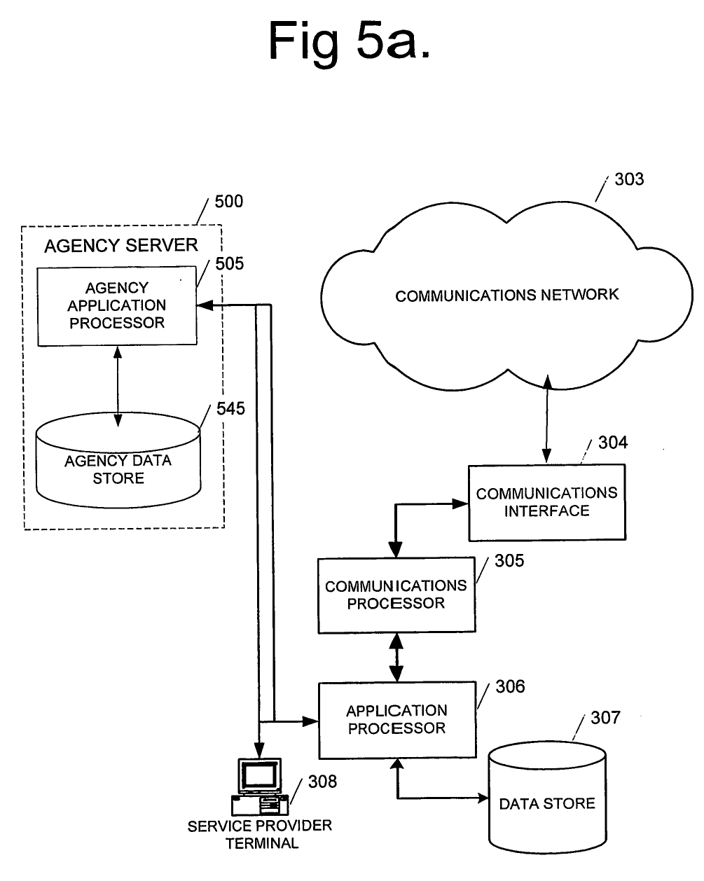

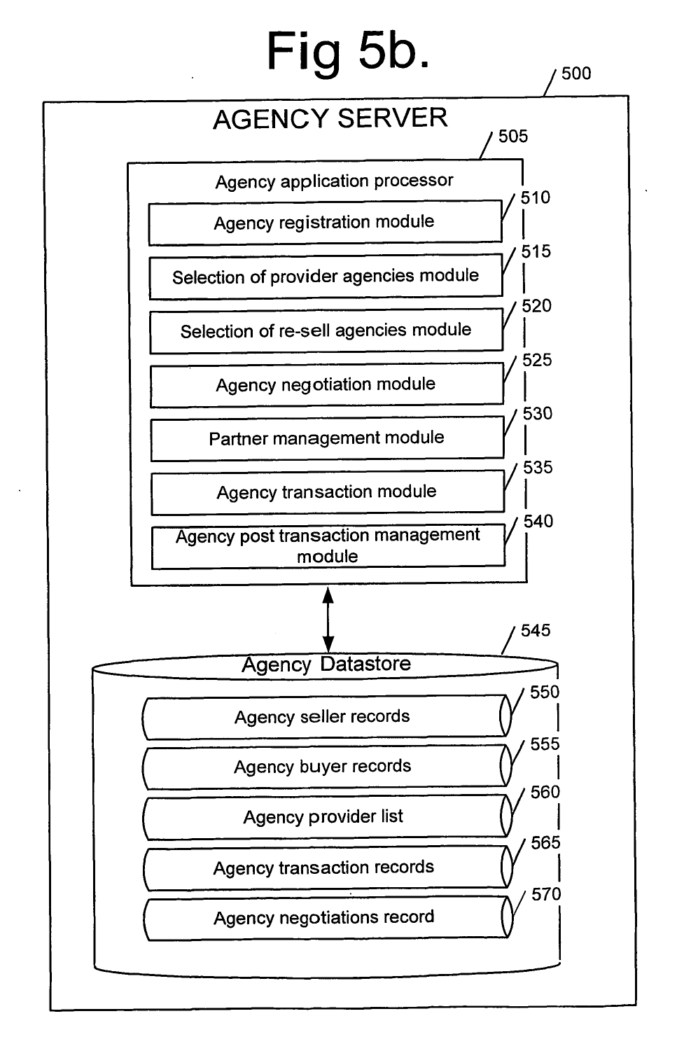

FIG. 5a illustrates how the agency server can interface with the marketplace, in particular Application Processor 306. All users communicate with the Application Processor 306 but a buyer or seller flagged as owned by a given agency is provided with pages drawing on branding and color display information pertaining to that agency held in Agency Datastore 545.

FIG. 5a. shows one embodiment of the architecture for the present invention. Alongside the architecture of the exemplary underlying online marketplace shown in FIG. 3 is agency server 500. This is linked to application processor 306 and service provider terminal 308. Agency server 500 contains agency application processor 505 which handles any aspect of a transaction in the underlying marketplace that involves an agency and agency data store 545 which stores all information pertaining to agencies within the system. It will be clear to those skilled in the art that the functions of agency server 500 could be incorporated within the overall architecture of the underlying system and the embodiment shown in FIG. 5a. is for exemplary purposes only.

Using Service Provider Terminal 308 staff working for the system operator can create a record for a new agency on the system. Said agency is then recorded on Agency Datastore 545. Once registered, an agency can create both buyer and seller records in the datastore 307. These buyers and sellers are “owned” by the agency who control the way in which they are displayed within the system. Their status as owned sellers or buyers is recognized with a flag on their record in Buyer Database 432 or Seller Database 431. Each agency can define commission built into the price on sales transacted through the system by its buyers. Buyers and sellers who access the system over communications network 306 such as the Internet are presented with a version of the system colored and branded as that of their owning agency.

Agency A can chose to re-sell the sellers of Agency B, or any willing agency on the system, to Agency A's buyers. Rules governing the construction of commission and its allocation between the two agencies are constructed jointly in advance. Partnership management programming ensures the ongoing consent of all concerned and continued compliance with agreements made. A list of prioritized partners for each agency defines the conditions of a buyer enquiry which will trigger a search of other agencies' sellers, the limits of that search and the order of search.

When a buyer owned by Agency A purchases a seller owned by Agency B a post-transaction module ensures allocation of commission. The agency datastore 545 within agency server 500 records details of any transaction involving one or more agencies.

FIG. 5b. shows the modules required within Agency Server 500. They comprise:

An Agency Applications Processor 505 this contains the following modules:

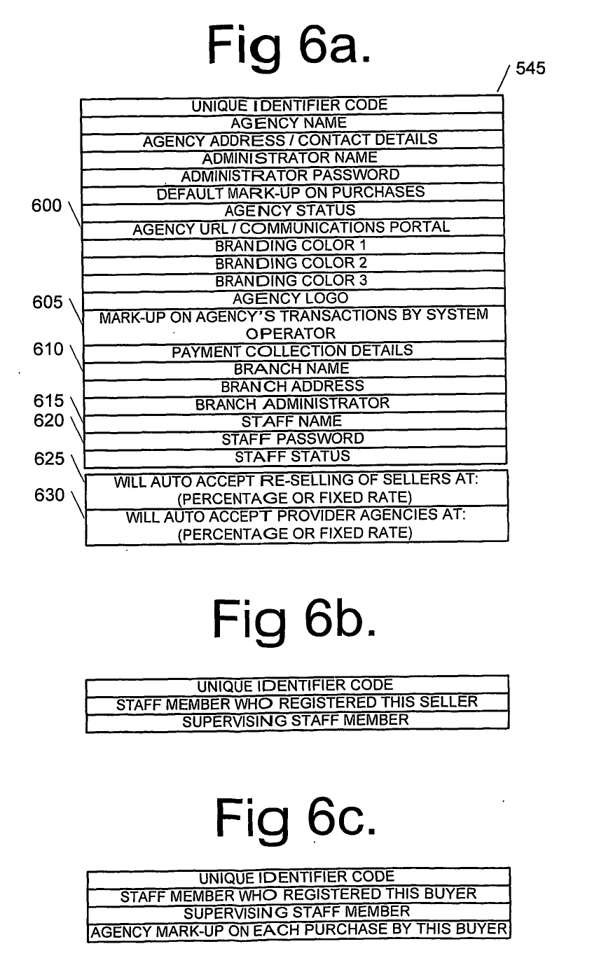

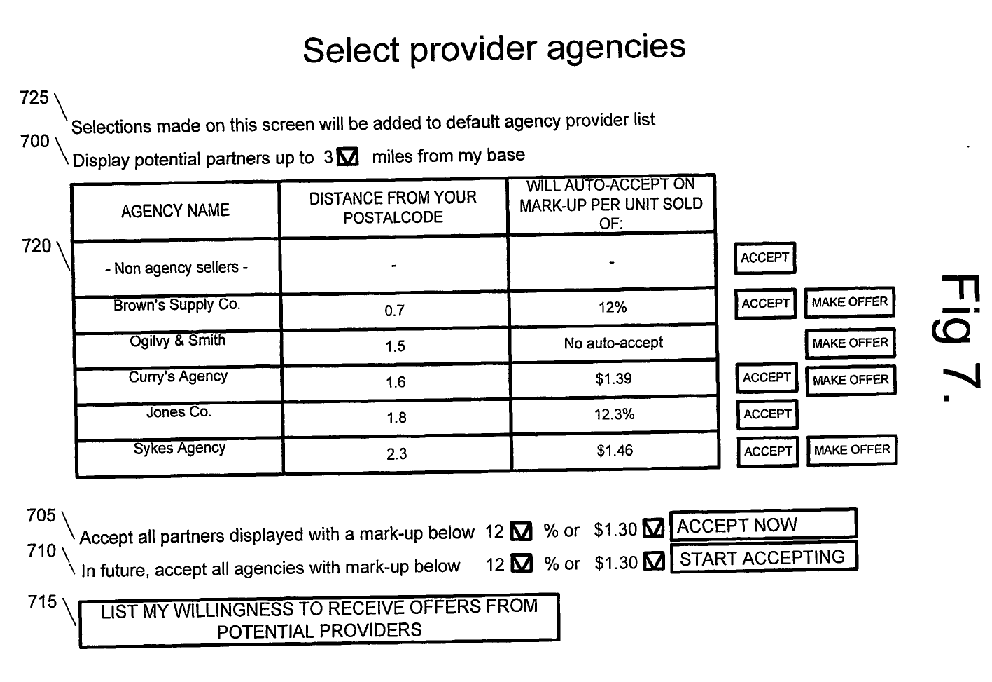

510 Agency Registration Module. This can be accessed only by the market operator through Service Provider Terminal 308 and sends pages that take in and validate the information required to create a new agency record in the Agency datastore 545. The information taken in at this stage is shown in FIG. 6a.

515 Selection of Provider Agencies Module. This module is accessed by administrators at any agency registered on the system. Using the screen illustrated in FIG. 7 it allows them to select agencies in the Agency Datastore 545 who have signified their willingness to provide their sellers to other agencies' buyers.

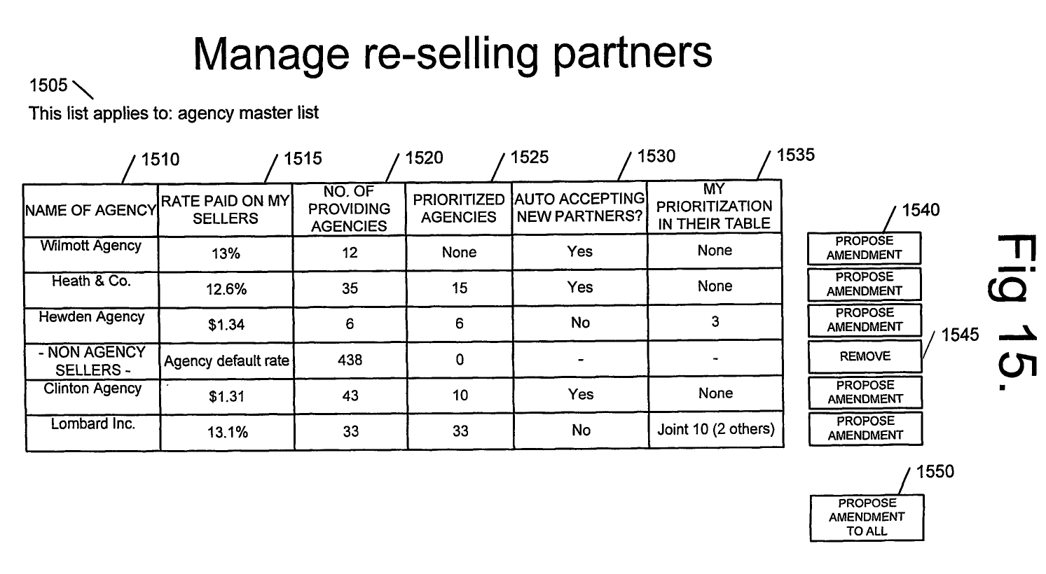

520 Selection of Re-sell Agencies Module. This module is accessed by administrators at any agency registered on the system. Using the screen illustrated in FIG. 14 it allows them to select agencies in the Agency Datastore 545 who have signified their willingness to offer sellers from other agencies to their buyers.

525 Agency Negotiation Module. This allows agencies to build a dialogue of negotiation aimed at establishing the rate at which one will re-sell the other's sellers to his buyers. This module may include a timer function that ensures offers lapse within a given timeframe if a user does not respond.

530 Partner Management module. This module enforces each agency's relationships with providers stored on Agency Provider List 560. As an example of its function, this module prevents Agency A from changing its terms of trade with Agency B without obtaining Agency B's consent through the Agency Negotiation module.

535 Agency Transaction Module. This module can supplant the Transaction Management module 223 within the core controller. It takes over parts of the operation of searching for options and constructing price when an agency is involved in a transaction. Typically it defines the pool of potential sellers to be searched and the order in which they are to be searched. It may also define elements of the unit price displayed to a buyer. It is triggered by Transaction Management module 423 and controls part of that module's process.

540 Post Transaction Management. This module is triggered by a change in job status in a transaction involving an agency. It ensures records of payments due to agencies are updated as a sale, or part of a sale, is completed.

545 Agency Datastore. Contains the basic information about each agency that is listed in FIG. 6a. Additionally it stores the following data for each agency on the system:

550 Agency Sellers Record. This contains a record of the Unique Identifier code of each seller who is owned by this agency on the Seller Database 431 within Datastore 307. Additional information on each seller is stored, as illustrated in FIG. 6b.

555 Agency Buyers Record. A record of the Unique Identifier code of each buyer who is owned by this agency on the Buyer Database 232 within datastore 307. Additional information on each seller is stored as illustrated in FIG. 6c.

560 Agency Provider List. A list of all the agencies whose sellers the named agency is entitled to display to their buyers. Also stored is the priority list by which provider agencies sellers are to be searched.

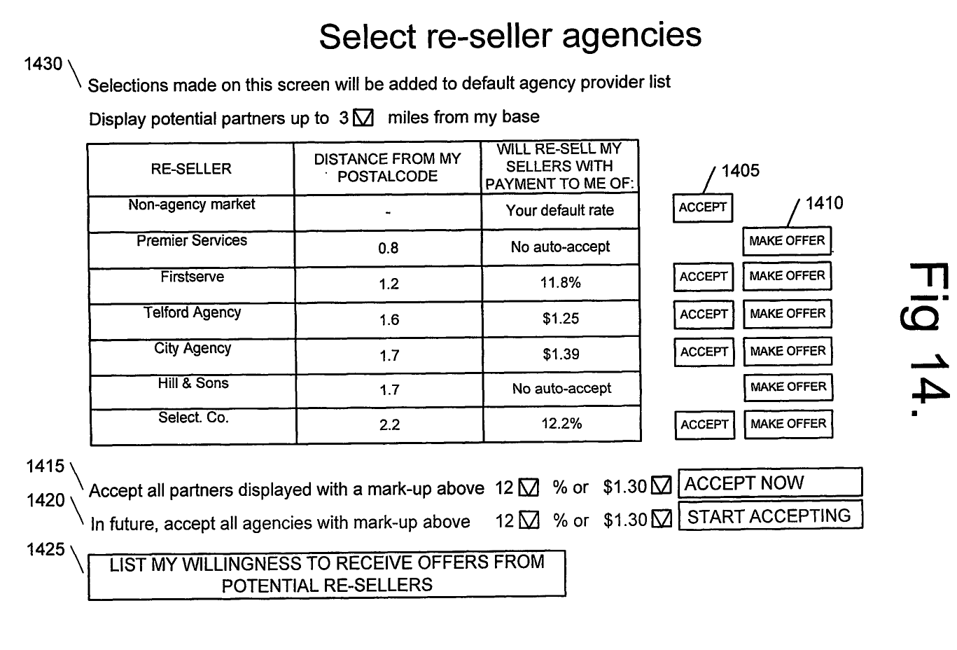

565 Agency Transaction Records. This database holds details each transaction in which the named agency owned either the buyer or the seller. Details of the data recorded is shown in FIG. 13.

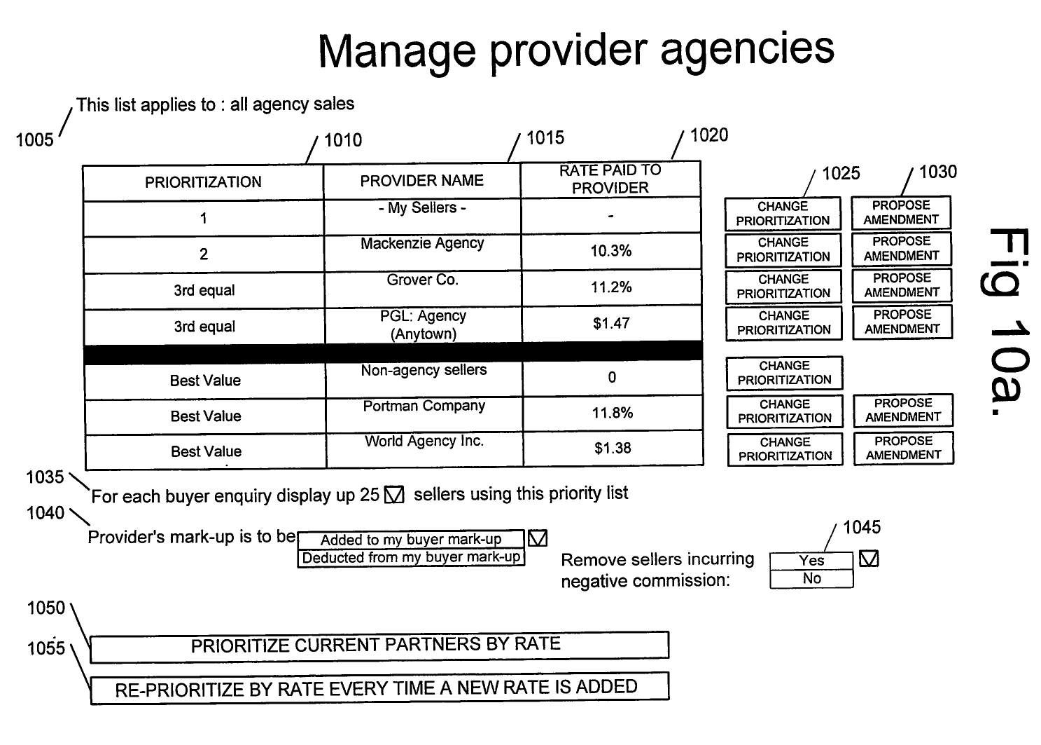

570 Agency Negotiation Record. Stores the negotiations conducted through the system between agencies. FIG. 9 shows a screen through which agency administrators are able to access details held on this record for their agency.

The functions performed by each of these modules will now be described in detail featuring illustrative transactions.

### Agency Registration

The market operator has access, via Service Provider Terminal 308, to a number of screens that take in the information required to record details of an agency joining the system. Said screens are generated by Communications Processor 305. The information entered is validated and recorded in Agency Datastore 545. Exemplary information required for each agency is shown in FIG. 6a. It includes branding information for that agency stored in section 600. This ensures a user accessing the system through an agency specific portal, for example an agency website, sees the system with defined screen elements in the agency color scheme with the agency logo displayed at a prescribed location on each page. Additionally information that can be input includes an individual rate by which the service provider chooses to mark-up this agency's transactions 605 which, if utilized, over-rides the standard commission charged by the system on non-agency buyers, and how payment is to be transferred by Payment Transfer module 427.

Similarly, each agency can set a default mark-up that will be added to the price charged to its buyers for whom no other mark-up instructions have been input. Commissions can be a percentage of the seller's unit price that is added to the price before it is displayed to the buyer or a flat-rate per unit mark-up, for example $1.35 per hour. All commissions are calculated independently of each other based on the seller unit price and number of units sold. In a preferred embodiment they do not compound but are added individually to form the final price shown to the buyer.

Once this record is established, those with administrator access at the agency can create additional staff identities 615 and passwords 620 using pages generated by communications processor 305. Information held on each member of staff belonging to an agency are shown in FIG. 6a.

Any member of agency staff can then create new buyers who are entered into database of buyers 432 but are flagged to show the agency that created them as owning them. Additionally a buyer record is created in Agency Buyer Record 555 this lists the unique identity code allocated to that seller in Seller Database 431 and then records agency specific information. This might include a specified commission to be built into any purchase made through the system by that buyer, either based on a percentage added to the seller's price or a flat fee per unit sold, that over-rides the agency's default mark-up on sales. FIG. 6b shows a sample field for one buyer in the Agency Buyer Record.

Likewise, any member of staff can register new sellers who are entered into database of sellers 431 and similarly flagged as owned by the agency by whom they were registered. A line is then created in the Agency Sellers Records 550. The information required for Agency Sellers Records is shown in FIG. 6c. There can be sellers within the seller database 431 who are not owned by an agency but have registered directly with the system. The same is true of buyers. These un-owned entities access the system without involving the present invention.

In a preferred embodiment all messages generated by the system to a buyer or seller are accessible to staff at that entity's owning agency. Similarly in this embodiment a member of staff can only operate on behalf of the agency that created their identity on the system, they can not access records or initiate actions on behalf of any other entity in the marketplace.

In one embodiment of the invention the creation of an agency record in Agency Datastore 545 creates an Entry Page for buyers, sellers and staff who are owned by that agency. This page is branded in agency colors with agency logo's defined in FIG. 6a at entry 600. It has a specific Internet address or communications medium locator and is openly displayed. Only if they enter through this portal will the user's password be accepted and access to the system allowed. The user can then fulfill all the functions of a buyer or seller in the wider market such as those described earlier. In the present embodiment a buyer or seller can only be owned by one agency.

It will now be clear that an agency exists as an entity on the system with its own staff who have the ability to register both buyers and sellers who are henceforth owned by the agency. An enquiry by a buyer belonging to an agency returns only qualified sellers also owned by that agency. Thus each agency can immediately allow its sellers to be sold to its buyers with a stipulated mark up built into the price and reserved for the agency. The way these agencies can inter-sell between themselves will now be explained.

### Selection of Provider Agencies

Provider agencies are those that allow their sellers, temporary workers for instance, to be displayed to buyers, such as employers, who are owned by another agency. In the present embodiment the consent of both agencies and a split in the commission charged to the buyer has to be agreed before this can happen. Such consent can be achieved after dialogue between the parties or by an agency displaying willingness to allow any other agency to re-sell their sellers subject to a particular commission rate being paid to the agency owning the seller.

Each agency is able to maintain a list of provider agencies and the terms on which their owned sellers can be displayed to the particular agency's buyers. The process for entering agencies onto the Agency Provider List 560 will now be explained. For illustrative purposes this document will talk of the agency that is establishing its relationships on the system as “Agency A” and assume they supply temporary workers to employers.

Staff with administrator level access at each agency are able to access a page showing potential provider agencies. This is shown at FIG. 7. By accessing this page the user triggers Selection of Provider Agencies Module 515 to search Agency Datastore 545 and deliver a list of agencies on the system currently willing to have their sellers sold through other agencies. How they register this intention is explained below under the heading “Selection of Seller Agencies”. Potential provider partners for this agency can opt to list either a percentage mark-up on the seller's rate which they must be paid from each successful transaction or a per-unit flat-rate mark-up which is charged regardless of the seller's unit price. They can chose to signify that they will immediately be a sub-vendor to any agency that will accept that rate. Or they may signal that they wish to have dialogue with each potential partner individually before instigating a relationship.

To take an illustrative example using FIG. 7.: Brown's Supply Co. are based close to Agency A and are willing to let their temporary workers be sold within another agency's branding to that agency's buyers as long as Brown's are paid 12% mark-up on the rate calculated by price construction module 425 as payable to the seller. If Agency A wish to accept this they simply click on the adjoining “accept” button. This ensures details of Brown's held on Agency Datastore 550 are linked to Agency A's Agency Provider List 560. The Figure of 12% to be paid to Brown's on any re-sale of one of their sellers is also thus recorded.

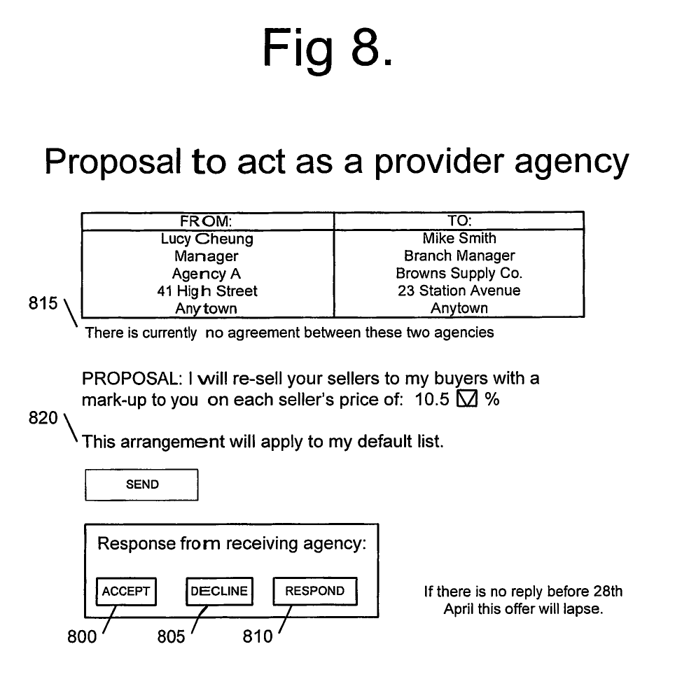

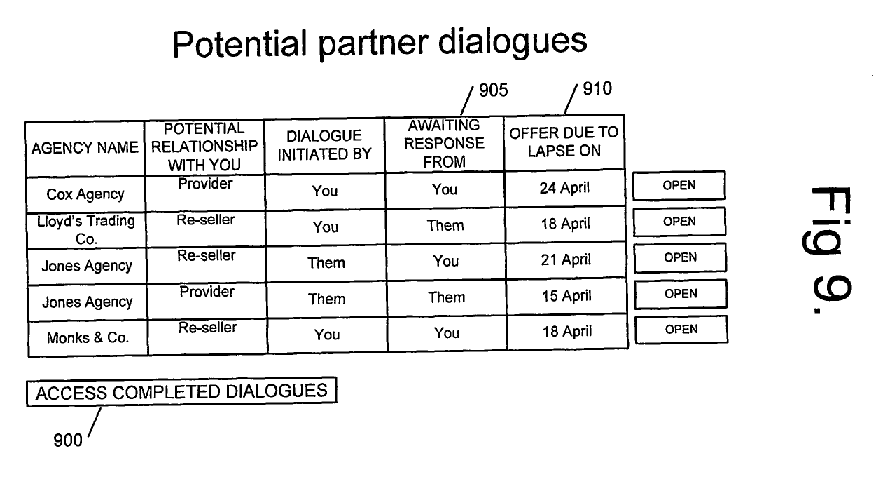

Instead of simply accepting the rate offered by Brown's, Agency A could select “make offer” and begin a process of negotiating a rate. They would then be offered a screen like that illustrated in FIG. 8. They might for instance start by offering to include Brown's on their Agency Provider List but only if Brown's will accept a 10.5% mark-up on their sellers who are bought by Agency A's buyers. Potential provider agencies can signify a willingness to negotiate with potential re-sellers but choose not to specify a rate at which they will allow this to happen immediately. The third agency on the screen represented by FIG. 7. has chosen that option and must be contacted before any re-selling is possible.

Before explaining the negotiation process further aspects of the screen represented by FIG. 7. will be outlined. Using the selection box 700, which runs from 1 to 100 and includes “show all” to signify the viewer wishes to see all agencies regardless of location, Agency A are able to specify the geographic distance from their own base in which they are interested in potential provider agencies. In an alternative embodiment they could select market sectors on the system and chose to have only agencies who have sellers registered to sell in those sectors displayed. In a further embodiment the two filters could be combined to allow instructions such as “show me agencies that sell nurses within 20 miles of my base postalcode”.

There are three options at the bottom of page represented by FIG. 7. The first labeled 705 allows Agency A to immediately accept all potential provider agencies displayed within the parameters they have defined using drop down box 700 who are showing that they will accept a mark-up of less than a Figure Agency A chose to enter. Using the screen shown for example if Agency A were to input 12.5% they would immediately gain 2 agencies on their Provider List. Likewise if they selected $1.50 they would gain another two. An X can be selected in either box, this signifies that Agency A will not work with, for instance, providers who demand a percentage mark-up but only those who accept flat-rate commission. The percentage box offers options from 0.1% increments, the flat fee inputs range is denominated in the smallest currency unit of the country of operation, the range of both is set by market operators using Service Provider Terminal 308.

The button at 710 allows Agency A to define a rate at which they will accept any agency on the system onto their Provider List 560 until future notice. That figure is stored in Agency Datastore 545 and is represented by line 625 and 630 in FIG. 6a. Any agency displaying a figure below that rate is immediately added to Agency A's Agency Provider List 560 by Partner Management module 530. Button 715 tells the Partnership Maintenance Module that Agency A is willing to consider approaches from other providers but will not offer a rate at which they will allow immediate access to their Provider List. This information is stored in Agency Provider List 560 and overwrites any information previously stored in line 625 and 630 in the database records represented in FIG. 6a.

In one embodiment of this invention agencies who have clicked on button 710 will trigger the Partner management module 530 to monitor agencies on their Agency Provider List 560. If one lowers the rate at which it will immediately accept re-sellers, that new rate replaces the old rate on the re-selling agencies Agency Provider List 560. This applies only if the provider agency has continued to stipulate either a percentage or flat fee mark-up. If it switches between the two their re-seller agencies are informed with a message.

In a further embodiment of the system the screen represented on FIG. 7 might include information from Agency Datastore 545 that would allow Agency A to assess the desirability of other agencies on offer as providers. Such information on each agency in the table might include (a) current number of registered sellers (b) number of units sold in a given time frame for example, “total number of temporary worker hours sold in the last 7 days” (c) percentage of those units that were sold through re-seller agencies (d) the agency's current number of re-seller partners.

In one further embodiment sellers who have entered the marketplace without an agency are available to be sold on by agencies. They are shown in row 720 in FIG. 7. Individual sellers may be given the option of deciding whether to be available for re-sale by an agency within the seller registration process 221. Those that decline are not included in searches for agency buyers even if that agency has signified a desire to re-sell non agency sellers. In these sales the non-owned sellers are treated as one distinct pool within the Agency Provider List 560 of a re-selling agency as shown in FIG. 7. Agency A can accept this pool of sellers by clicking the “accept” button adjoining row 720 the commission rate to be paid to owning agency for these sellers is set at zero.

### Negotiations Between Agencies

Selecting “make offer” on any option offered by the screen illustrated in FIG. 7 takes Agency A through to a page represented in FIG. 8. Within this page Agency A can make an offer of the mark-up they would allow this specific provider agency on their sellers who are sold to Agency A's buyers. In a preferred embodiment the system calculates a time by which each offer between the two parties will lapse, this ensures an agency does not make offers which elicit no reply at the time but are suddenly reactivated when market conditions change later. Seven days might be the period selected by market operators using service provider terminal 308.

Once Agency A clicks on “SEND” within the screen shown in FIG. 8 this page is sent via communications processor 305 to the administrator at the potential provider agency who is named, together with email address, in Agency Datastore 545. The page shows initially as a “message waiting” on his screen either immediately if he is logged on or at next log on. All inputs pertaining to negotiations between agencies are stored in the Agency Negotiations Record 570 of the two agencies involved.

The recipient agency can chose to accept the rate offered by Agency A using button 800 or end the negotiation using button 805 which generates a message to Agency A informing them that this was the response. Alternately the recipient agency can make a counter offer using button 810. This duplicates the template of the screen in FIG. 8 below the existing screen with the “From” and “To” boxes reversed. The recipient agency administrator can then select the rate they wish to offer Agency A. Clicking the “Send” key sends that new offer to Agency A's administrator with a new time when the offer will lapse calculated based on the time the “Send” key was clicked. This process can continue indefinitely with all the offers visible as the screen creates new offers sequentially below the failed offers. At any point when a receiving agency selects “Accept” on an offer from the other agency the agency approached as potential provider is added to the Agency Provider List 560 of the initiating agency.

In an additional embodiment this page might feature a box for entry of text entered by the message sender. This would allow the parties to explain why they felt the rate was fair and why it would be a good deal for both parties. The administrator at any agency on the system is able to access a page displaying all the dialogues currently in progress and act on them accordingly. It is represented in FIG. 9 and will now be described. Button 900 allows the user to recall dialogues that have either ended with a deal, timed out or ended in rejection by either party from Agency Negotiations Record 570. They are listed in order of most recent end date on the screen represented by FIG. 9. In this mode of display the screen shown in FIG. 9 changes so that button 900 displays “show current dialogues”, column 905 displays “dialogue ended by” with options (you/them/timer) and column 910 displays “date dialogue ended”.

“Open” button 920 adjoining each dialogue on this screen allows the user to see the most recent version of the screen represented in FIG. 8 for this dialogue. A further message to the other party can then be sent from this screen regardless of which side was last to respond.

### Partnership List Maintenance

It should now be clear that Agency A is able to add other agencies to its Agency Provider List 560. These are all agencies that are willing to allow Agency A to display their sellers to buyers accessing the system who are owned by Agency A. There is thus a need for Agency A to be able to prioritize that list of provider agencies and make amendments to their relationships.

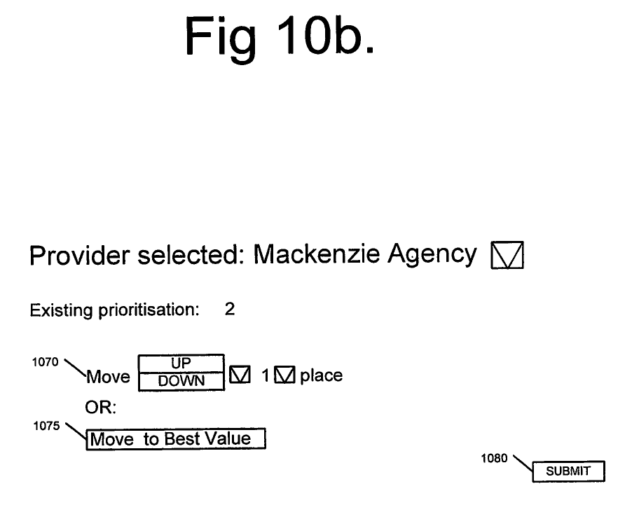

FIG. 10 shows the page by which Agency A are able to manage their options regarding provider agencies. There are two aspects to this (a) the target number of sellers to be displayed to a buyer, for example, this can range from 1 to 50, this determines how far down the list the assembly of options module 424 needs to go before returning sufficient sellers for display to a buyer (b) the prioritization of sellers from provider agencies, including sellers owned by Agency A themselves, in the search for that target number.

The number of sellers to be returned in response to a buyer enquiry is called the Target Number, it is set using the drop down box at line 1035. This information is stored in Agency Provider List 560. This document will now turn to the means by which Agency A can prioritize the agencies on its provider list.

By default the system assumes Agency A's sellers are the first to be searched for any enquiry. If the Target Number of sellers can be found, or exceeded, from Agency A's own pool then no provider agencies' sellers are searched.

If the number can not be reached from Agency A's own sellers the system's default setting is that all other provider agencies are secondary to Agency A but categorized as “Best Value”. That is, equal among themselves with sellers ranked purely on price for the buyer's needs. For example, assume the target number is 25. A search of Agency A's sellers reveals only 10 sellers with the required qualification, availability, willingness to undertake an assignment with the specified parameters and who can be contacted in time. The system will ring-fence those 10 then search all provider agencies' sellers. Assume that search turns up a further 20 sellers. They are priced and the most expensive 5 dropped. The 10 from Agency A and the 15 from provider agencies are then sent to the display module 210 to be shown to Agency A's buyer.

In a further embodiment each agency is able to define the prioritization of its list more exactly. The list is divided between prioritized providers who are searched in order and those who are not prioritized and used only for top-up on a “best value” basis as required. Turning again to FIG. 10a it will be seen that the first four agencies on the list are prioritized, while the lower three are not. In this case assembly of options module 424 responding to a specific buyer request will work its way down the list progressively.

The place of any agency on this list can be changed by selecting “change prioritization” button 1025 adjoining the selected agency. In one embodiment this brings up a page represented in FIG. 10b which requires the user to select a new ranking for the chosen agency. If a ranking that already exists is chosen the user is asked “is this agency to have this ranking alone or equal to the existing agency at this rank?”. Selecting “alone” pushes all agencies at that rank and below down one place in the prioritized list. Selecting “equal” allows the formation of equal rankings, for example two or more agencies being joint third in the list. In these cases assembly of options module 424 treats both as one pool of sellers for the purpose of the search. “Best Value” agencies are likewise treated as one pool of sellers. Changes in prioritization are stored in Agency Provider List 560 for the agency concerned.

In an alternative embodiment agencies can be drag-and-dropped into a new order on the screen with the new display being uploaded to the server. It will be appreciated that there may be times when an agency chooses to move its own sellers down the prioritization table in response perhaps to a promise to buyers that a particularly attractive pool of sellers owned by another agency be prioritized first. The agency's own sellers are treated as one pool that can be moved up or down the list and can be displaced from the top position.

Further facilities on the screen shown in FIG. 10a will now be described. The authorized user can attempt to amend the mark-up built in to each price for the provider agency by selecting “propose amendment” button 1030. This triggers the negotiation process shown in FIG. 8 except that line 815 is changed to read “there is currently an agreement between these two agencies”. If no agreement is reached within the time set by the system the provider agreement lapses and that agency is removed by the Partner management module 530 from the agency's Agency Provider List 560. Agency A could restore the original rate at any time by inputting it into the box on FIG. 8 and waiting for the other agency to click “accept”, it will be clear that this will turn the timer off. The procedure described ensures that relationships can not be terminated without warning which could be unfair to provider agencies.

Turning now to the calculation of price displayed to a buyer. Details held within Agency Provider List 560 are displayed in the table shown in FIG. 10a. They include the mark-up to be built into each purchase price for the owning agency that has been agreed between the two agencies, either through auto acceptance or after negotiation. This will be calculated on the basis of the seller's unit price for this sale in the case of percentage mark-ups or added as a flat-rate per unit sold.

For each buyer owned by Agency A there is a mark-up instruction stored in Agency Buyer Records 555, this may be the agency default setting or an individual instruction for that buyer. This is either a percentage or a flat-rate fee to be added to each unit sold. The re-selling agency can now stipulate if the provider agency's commission is to be subtracted from the commission rate calculated for buyers so the re-sell agency Forgoes its full commission rate to hold an agreed supplier rate with a buying company for instance, or if the two commissions are to added to it so the re-selling agency gets their full commission. This selection is made in line 1040, by default it assumes the two commissions will be added.

In a preferred embodiment the system will warn an agency that selects “subtract” if any of the commission rates listed on the Provider List 560 are below or equal to any comparable buyer mark-up rates either percentage or flat fee per unit sold stored on their Agency Buyer Record 555. The function of button 1045 will be explained shortly.

In a further preferred embodiment button 1050 an Agency can prioritize their list purely on the basis of the lower the agency rate the higher up the list they come. In a further preferred embodiment button 1050 lets the authorized user select an option that ensures the Partnership List Maintenance module 530 will re-prioritize the list every time a new agency is added or the rate for an existing agency is changed. It will be appreciated that this might be useful for an agency that is automatically accepting new providers at any time.

### Agency Transaction Management

It will now be clear that Agency A have been able to create (a) a pool of sellers which are flagged on the Seller Database 431 as owned by Agency A. (b) a pool of buyers which are flagged on Buyer Database 432 as owned by Agency A (c) rules governing mark-up calculations to be added to purchases by each owned buyer (d) rules governing any additional price calculations for individual owned sellers (c) a Target Number for the number of sellers to be displayed in response to a buyer's enquiry where that buyer is owned by Agency A (f) a prioritized list of agencies whose sellers will be searched in pursuit of said target Number (g) the mark-up to be paid to each agency on that list and whether it is an addition to Agency A's commission charge or to be subtracted from it.

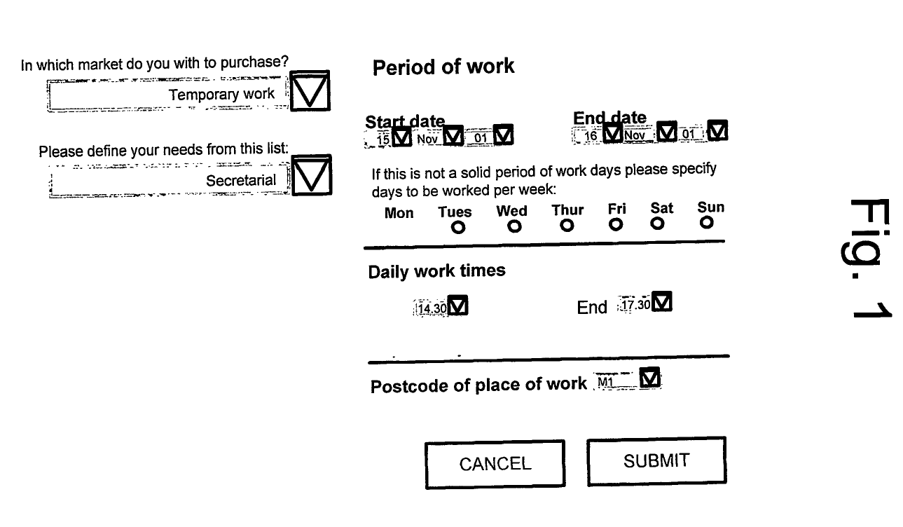

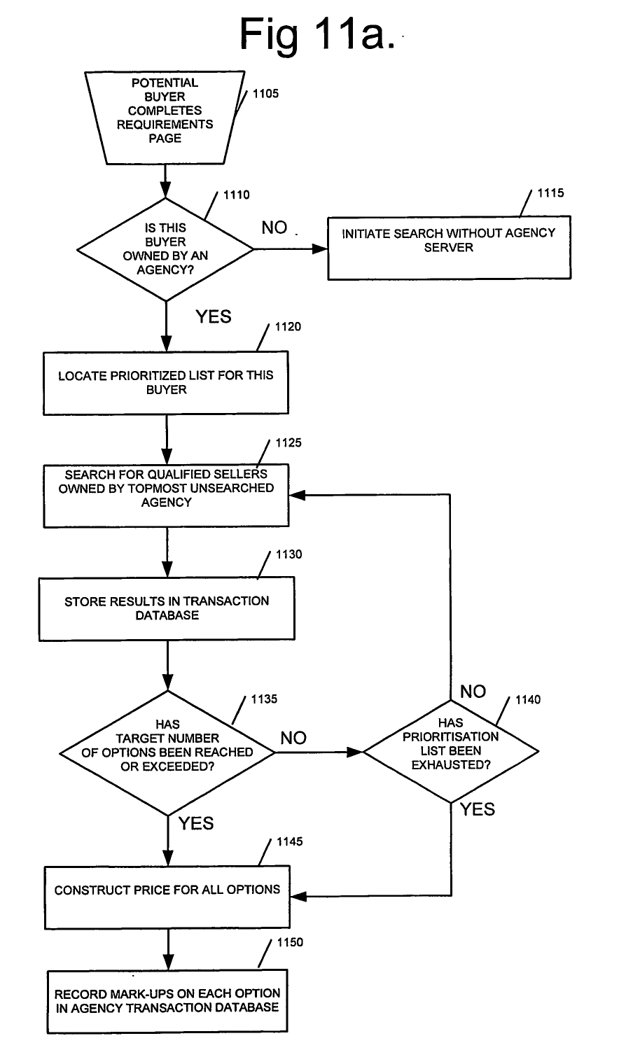

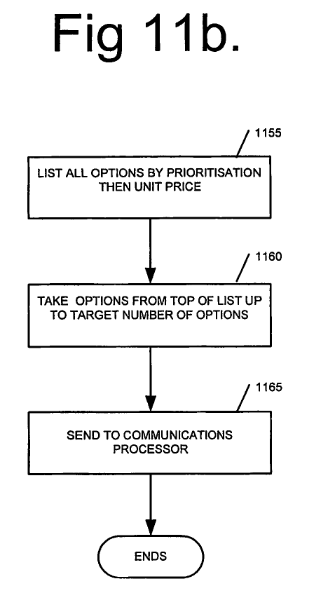

This document will now turn to the process instigated when a buyer wishes to make a purchase. The search process is shown in FIG. 11a and FIG. 11b. It is initiated when a buyer logs on, signifies that he wishes to make a purchase and is offered a buyer input page as illustrated in FIG. 1. He completes this page and clicks “submit” at step 1105. After checking for inconsistent data, a start date before today's date for instance, which leads to a “please re-key your data” warning, the search process begins.

At step 1110 the Transaction Management module 423 within the Application Processor 306 reads the buyer record in Buyer Database 432 to see if this is a buyer owned by an agency. If he is not the present invention is not required and the transaction proceeds in the non-agency market.

At step 1120 assuming the buyer is owned by Agency A the Agency Transaction Module 535 now reads the current Provider List 560 for Agency A. At step 1125 the Agency Transaction Module instructs the Assembly of Options module 424 within Applications Processor 306 to search only sellers flagged as owned by the topmost provider on the list, in this example Agency A's own sellers. At step 1130 search results are stored in the Transaction Database 223 against the Unique Identifier assigned to this enquiry.

The Transaction Management module 223 then uses Agency A's Target Number of 25 sellers to over-ride the default market operator setting for maximum number of options to be displayed to a buyer. Agency Transaction Module 535 checks if the Target Number of sellers who are qualified/available/willing/contactable for this requirement has been reached or exceeded at step 1130. If it has Agency Transaction Module 535 sends the search results to Price Construction Module 425. If not, and the list has not been exhausted when checked at step 1140, Agency Transaction Module 535 commissions a search of the next pool of sellers on the Provider List. Where this is a joint entry or “best value” entry the pools of sellers are combined for purposes of search into one pool and searched equally.

Once the target number of sellers has been reached or exceeded, or Agency Provider List 560 has been exhausted, Agency Transaction Module 535 sends the results to the Price Construction Module 425 at step 1140. It will be clear to those skilled in the art that if there are no search results at all a message will need to be generated at this stage informing the buyer of this.

At step 1145 the unit price for each seller for this particular requirement is calculated by Price Construction Module 425 within Application Processor 306. Once that unit price is known Agency Transaction Module 535 reads Agency Buyer Record 555 to find the mark-up to be added by the agency owning the buyer. It then turns to Agency Provider List 560 to determine how the provider agency's commission is to be calculated and whether it is to be subtracted or added from the re-seller agency commission. It will be clear that on some transactions this will require calculations that embrace a flat per-unit fee mark-up for one agency and a percentage mark-up for the other. Some examples of commission calculations are shown below.

| Instruction | | Provider | Seller Agency | Commission | Amount owed | Amount owed |
|---|---|---|---|---|---|---|
| input at line | Seller | Agency | charge to | added to the | to Provider | to Selling |
| 1040 in FIG. 10a. | unit price | commission | buyer | seller price | Agency | Agency |
| Add | $10 | 10 percent | 15 percent | $2.50 | $1 | $1.50 |
| commissions | | | | | | |
| Subtract | $10 | 10 percent | 18 percent | $1.80 | $1 | $0.80 |
| provider | | | | | | |
| agency's | | | | | | |
| commission | | | | | | |
| Add | $10 | Flat fee: | 15 percent | $2.00 | $0.50 | $1.50 |
| commissions | | $0.50 per | | | | |
| | | seller unit | | | | |
| Subtract | $10 | 15 percent | Flat fee: | $1.75 | $1.50 | $0.25 |
| provider | | | $1.75 per | | | |
| agency's | | | seller unit | | | |
| commission | | | | | | |

It will be clear to those skilled in the art that when the instruction is “subtract provider's commission” there is a danger of the “amount owed to selling agency” coming out as a negative figure and that this could not have been clear until the seller's unit price for this specific transaction was calculated. This is illustrated in the example below.

| Instruction | | Provider | Seller Agency | Commission | Amount owed | Amount owed |
|---|---|---|---|---|---|---|
| input at line | Seller | Agency | charge to | added to the | to Provider | to Selling |
| 1040 in FIG. 10a. | unit price | commission | buyer | seller price | Agency | Agency |
| Subtract | $10 | Flat fee: | 18 percent | $1.80 | $2 | −$0.20 |
| provider | | $2.00 per | | | | |
| agency's | | seller unit | | | | |
| commission | | | | | | |

In a one embodiment of the present invention the “Existing Provider Agencies” page illustrated at FIG. 10a shows how an agency can decide whether to allow these negative commission transactions using the selection box (“Yes” or “No”) in line 1045. They may choose to do so as part of their contractual commitments to a buyer for instance. In such a case Payment Transfer module 427 in Application Processor 306 records that the Selling Agency owes the Provider Agency the difference between commission charged to buyer and commission paid to Provider Agency per unit multiplied by the number of units.

If the Selling Agency have not allowed negative commissions any such sellers are removed from the list. If this brings the list of sellers for this transaction below the target number of sellers the Agency Transaction Module 535 will then return to step 1120.

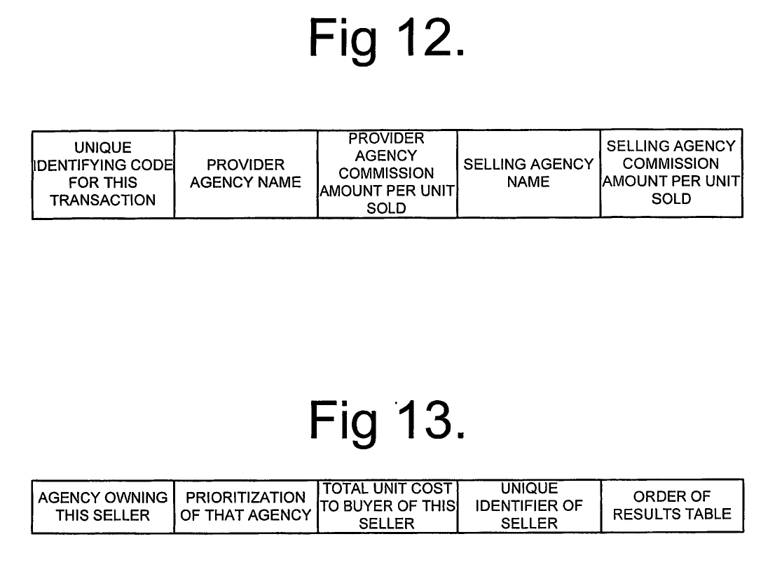

At step 1150 the data in the above table about each seller is stored in Transaction Database 433 against the unique identifier code assigned to this enquiry with details of agency mark-ups attached to the transaction stored in Agency Transaction Records 565. The data stored is shown in FIG. 12.

Turning now to FIG. 11b. At step 1155 the list of sellers for this transaction is ordered firstly by Provider Agency and, in a preferred embodiment, within each Provider sellers are listed in order of lowest cost for the buyer. The table for each transaction is shown in FIG. 13. This information is stored on Transaction Database 233 against the unique identifier code for this enquiry.

At step 1160 the highest number of sellers possible up to the target number of sellers are selected by the Transaction Management Module 423. They are then sent to Communications Processor 305 to be displayed according to the appropriate communications device used by the buyer.

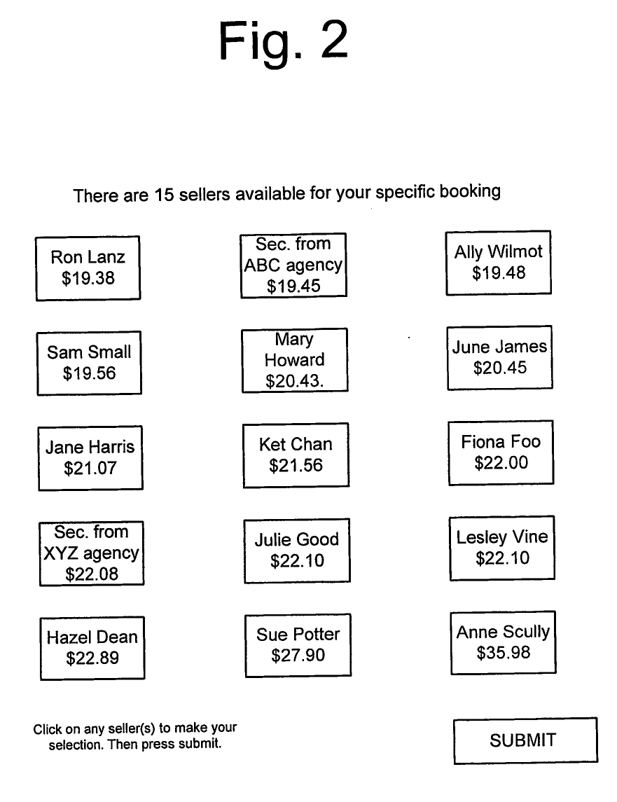

Once given the screen showing purchase options as suggested in FIG. 2 the buyer can select whichever options he wishes to buy and the sale process is handled by Application Processor 306 as explained in the background to the present invention. Once a purchase is made details are added to the transaction database 233. Additionally, a transaction involving one or more agencies generate a field in the Agency Transaction Record 565 for the agencies involved. Those fields are shown in FIG. 12. In an alternative embodiment the Transaction Database 233 in the Application Processor 306 is supplemented with the addition of new columns as shown in FIG. 12.

Payment Transfer Module 427 then ensures either invoices are issued or stored value transferred between entities on the system according to rules set out in Market Rules Database 236. These entities include agencies whose Receive Payments and Make Payments instructions are stored in Agency Datastore 545 in a form that will be well known to those skilled in the art.

### Selection of Re-Sell Agencies

It will be apparent that the above pages have described processes where Agency A is the re-selling agency using other agencies as providers of sellers. It must now be explained how Agency A becomes a provider to other agencies who might wish to re-sell its sellers.

FIG. 14 represents a page that can be called up by administrators at any agency registered on the system. It shows all agencies who have indicated an interest in recruiting provider agencies and, if they have entered a rate to be paid to the provider agency at which they will immediately conclude an arrangement, what that rate is. They have input this information using the screen represented at FIG. 7 using either button 710 to enter a rate or button 715 to show a willingness to enter into negotiations through the Agency Negotiation Module 525. Agencies that show both button 1405 and 1410 on this screen have clicked on both button 710 and button 715 on the screen represented by FIG. 7.

By selecting “Accept” for any option on the list in FIG. 14 Agency A is added immediately to the Provider List 560 of that agency, at the bottom of the list under “best value” by default. FIG. 10 shows how that agency can then manage prioritization of their Provider List. If Agency A select “make offer” the negotiation process already described and illustrated by screen displays shown in FIG. 8 and FIG. 9 is initiated with the heading in FIG. 8 changed to “Proposal to act as a re-seller agency”. Once a rate is accepted by both parties, either immediately or after negotiation, Agency A is added to the Provider List of the other agency at the rate agreed.

In a further embodiment of the present invention which assumes there are both agency owned buyer and sellers and non agency owned buyers and sellers in the market it is possible for an agency to chose to have its sellers displayed to buyers who have entered the market without being owned by an agency. In these cases the agency's sellers are flagged in Seller Database 431 as available for non-agency buyers but that agency commission must be calculated according to the default rate stored in Agency Datastore 545 and this is added to the seller unit price by Price Construction Module 425.

In one embodiment of the present invention the display illustrated by FIG. 14 is supplemented with data that allows the viewing agency to assess the desirability of potential selling agency partners. Information about each agency displayed might include (a) number of registered buyers (b) total buyer spend over the last 7 days (c) percentage of sales to buyers in which a provider agency was involved in the last 7 days. The data is extracted from the Transaction Database 433 within Application Processor 306. It will be clear to those skilled in the art that a period other than 7 days could be selected by the viewer.

For ease of use, the viewer of the screen display represented in FIG. 14 is able to accept all potential selling partners on the screen who will allow Agency A as provider of the seller a commission rate above their selected amount. This is done by clicking the “accept now” button on line 1415. They are also able to signify a desire to provide their sellers to every agency on the database that will allow them a rate above a second chosen percentage or flat-rate amount. Button 1420 accepts this instruction and enters it in the Agency Datastore 545 in line 630 shown in FIG. 6a. If “Accept” is selected on button 1420 the amount chosen and the accompanying text is then displayed in gray. The button function, and text, changes to “Cancel Automatic Acceptance”.

In one embodiment of this invention if Agency A have clicked on button 1420 it will trigger the Partner management module 530 to monitor agencies re-selling Agency A's sellers. If one of them raises the mark-up rate (but remaining within the context of either percentage or flat fee) at which it will immediately accept providers, that new rate automatically replaces the old rate on the provider's re-seller lists. If a re-seller agency switches from a percentage mark-up to a flat-fee mark-up a message is triggered for the provider agencies who can then decide whether to propose an amendment to their current agreement.

Button 1425 allows an agency to display willingness to enter the negotiations process shown in FIG. 8 whether or not they have also stipulated a rate at which they will automatically accept another agency as a re-seller.

### Managing Re-Seller Agencies

It will be clear that agencies need a way of viewing the list of agencies to whom they have agreed to provide sellers and the rates at which they have agreed to do so. FIG. 15 illustrates a screen by which Agency A can view, and seek to amend, their existing relationships with agencies who re-sell Agency A's sellers. The table shows (a) agency name (b) the rate currently being paid to Agency A when the re-selling agency sells an Agency A seller to one of the re-seller's buyers (c) the current number of entries on that agency's Agency Provider List 560 (d) how many of those agencies are prioritized on the Provider List, that is they are searched before the “best value” pool is reached (e) whether this agency selected the option at 710 on FIG. 7 to automatically grow its list by accepting agencies who enter a mark-up rate below their chosen amount (f) the current place of Agency A on the Agency Provider List of the other agency.

In a preferred embodiment of this invention Agency A is not allowed to cancel an agreement immediately. The other agency might be reliant on their agreement with Agency A to provide sellers for a large client for instance. Therefore neither party can unilaterally cancel the provider agreement. However Agency A can select “Propose Amendment” at button 1540. This starts the negotiation process already described and illustrated in FIG. 8 with line 815 changed to read “there is already an agreement between these two agencies”. If a new Figure is not agreed between the two parties within the time set by market operators for Inter-agency communication time and input through Service Provider Terminal 308, for example 7 days the agreement is then cancelled and Agency A is removed from the other agency's Agency Provider List. Agency A could restore the original rate at any time by inputting it into the box on FIG. 8 and waiting for the other agency to click “accept”, it will be clear that this will turn the timer off.

In a further embodiment an agency would be able to sell its sellers to buyers who are not owned by an agency. This arrangement can be cancelled at any time by the agency because there is no partnering implied. Button 1545 provides this function.

In a further preferred embodiment the viewing agency is able to use button 1550 on the screen illustrated in FIG. 15 to select “Propose Amendment to All”. This would be used if an agency wished to re-negotiate all its contracts with provider agencies. This button would generate a version of the negotiation form shown in FIG. 8 that would be addressed to each of agency which had Agency A listed on its Agency Provider List 560. By inputting one rate at which they would now re-sell the Provider agency would trigger an individual message to each re-selling partner who could then respond or let their agreement lapse once the inter-agency communication time had ended.

### Further Examples

Although the formal temporary work market has been used throughout as an example it should be clear that the system described could usefully be applied to other markets in which there is a plurality of re-sellers each with at least one buyer or seller. These include without limitation: courier agencies, vehicle hire agencies, ticket agencies for example within the entertainment industry, online galleries selling greetings cards painted to order by artists, domestic services agencies providing house cleaners, child carers and the like, real estate lettings companies providing accommodation for rental, agencies hiring items owned by other parties for instance construction equipment, middlemen enabling hire of specialized facilities belonging to a plurality of sellers such as television editing facilities or sports facilities. In all cases agencies can be online or offline.

### Additional Embodiments

The preceding description has outlined a basic version of the present invention. Various additional embodiments are described below as modifications to the system described above.

### Buyer Specific Partnering Embodiment

In this embodiment an equivalent for Agency Provider List 560 can be constructed for an individual buyer. A temporary work agency for instance might have 3 large clients (employers) each of whom has specified a different list of sub vendors, sometimes called a Preferred Supplier List, and the rates to be paid to them. This embodiment allows the agency to call up the screen shown in FIG. 7 and amend line 725 which now contains a list of all their clients plus a top setting of “agency default” which applies if no client specific Provider List is selected.

Once a client has been selected, all instructions on this page apply only to that client with inputs going to an additional Provider List stored within Agency Provider List 560 but only accessed for purchases by staff of that buyer. Step 1120 in FIG. II would ensure the correct Provider List was accessed by checking against the buyer's identity for an individual client list stored in Agency Buyer Records 555. The following changes to pages would also be required for client specific partnering: (a) FIG. 8 line 820 becomes “this arrangement will apply only to my client (name of client)” (b) FIG. 10a line 1005 changes to “this list applies to: (name of client)” (c) FIG. 15 is supplemented by a column headed “number of preferred supplier lists in operation” and a further column headed “number of preferred supplier lists in which you are included”. All further embodiments of the Agency Provider List 560 apply equally to an agency default list or a client specific list. It will be clear to those skilled in the art that a buyer specific provider list can readily be duplicated from one buyer to another by using a “duplicate settings of” option followed by a selection box of all other buyers belonging to the present agency.

### Transfer of Sellers Embodiment

It will be clear that agencies are able to add considerable value and character to the intended marketplace. This will result in sellers who wish to move between agencies for instance because they believe an alternative agency will promote them to more buyers. However, if this was an immediate process, agencies would not be incentivized to sign up new sellers because the costs of doing so are early on and the payback is gained later as the seller completes increasing numbers of sales. If Agency A incurs all the costs of putting a seller in the market it is not desirable that the seller can then immediately be tempted to transfer to Agency B.

There therefore exists a need for some form of phased payment between the two agencies. A sliding scale of percentage payment to the original agency would be established with some of the commission earned by the new agency on that seller diverted over a set time frame defined by the system operators through Service Provider Terminal 308. To give an example it may be that the transfer period is six months and that at the start of that period, the day the seller is transferred to ownership of the new agency, 75% of new agency's earnings on that seller are diverted to the original agency. That could decrease over 6 months (in daily increments) by which time the transfer percentage is zero. This would be achieved by Agency Post Transaction Module 540 with the process triggered by a screen that had to be signed with passwords by the seller and both agencies, originated by any one of them and generated by Partner management module 525. Such screen may conceal the exact financial arrangements from the seller. Agency Seller Record 550 would then be expanded to include a “previous agency” flag.

In a further embodiment the transfer percentage outlined above could be amended by the two agencies once the seller had input their desire to change ownership. Likewise buyers can be transferred without establishing a new identity using the page just mentioned. It is unlikely large buyers would allow a significant transfer percentage. In a further embodiment a seller might not be allowed to transfer between agencies if they had already done so within a time period set by the market operator using Service Provider Terminal 308. In an additional embodiment the seller transferring may be required to input their password against an online contract that ensures they do not then transfer again within a specified timeframe, said agreement then being enforced by User Maintenance module 428.

### Multiple Ownership Embodiment

In the offline world of middlemen a seller is often represented by several agencies. This could be replicated in the present invention. The case of a seller will be described first. This entails a plurality of agency flags on the record in Seller Database 431. With the seller being counted as belonging to any one of those agencies for the purpose of search by Agency Transaction Module 535. Where a seller is owned by two or more agencies on a prioritized list the agency offering them at the lowest mark-up for that transaction might be deemed to be the owner (see below for how the system compares a percentage rate with a flat Fee rate between agencies). If two or more agencies offer identical rates the agency for whom the seller has completed most transactions might be deemed the owner. Alternatively the agency who registered the seller first might be deemed the owning agency. Alternatively it could be the first agency to produce that seller as a return during the search illustrated in FIG. 11a. is deemed the owner.

A buyer can have multiple ownership, likewise recorded with a plurality of agency flags on their record in Buyer Database 432. They could be registered by one agency using Agency Registration Module 510 and then accessed, with their consent shown by inputting a temporary password input originally by the buyer and re-keyed by the additional agency. Thus a further agency also registers them as owned without re-keying all the registration details. The buyer then chooses which URL or other portal he uses to make a purchase. That purchase is deemed to be owned by the agency whose portal he chose to enter the market at that time with mark-up and Provider List 560 as recorded against that agency.

### “Remove all Sellers” Embodiment

It is known that agencies in many markets have advance warning of periodic transactions which will require them to supply unusually large numbers of sellers. A short term accommodation letting agency that is aware of a local event that will bring considerable numbers of incomers to their city of operation is one example. In such cases an agency may wish to temporarily suspend agreements to supply sellers to rival agencies.

In the present embodiment the screen represented in FIG. 15 is supplemented by a button offering “withdraw my sellers from other agencies on bookings between (date input) and (date input)”. Thus the appropriate agency would be dropped from partner agencies' Agency Provider List 560 for any transaction that required delivery within the specified timeframe.

In a further aspect of this embodiment all such re-sell partners would be informed of this change to arrangements by (a) a “temporarily withdrawn” flag on their version of the screen represented by FIG. 15 with the viewer able to click through to dates of the amendment and whether it applied to all agencies or only X agencies out of a total list of Y agencies (b) an email to the nominated point of contact for each agency impacted.

### Intermediary Agencies Embodiment

It will be appreciated that if Agency A regards Agency B as maintaining quality and character of sellers sufficiently for those sellers to be provided to Agency A's buyers under Agency A's branding then those agencies selected by Agency B as suitable provider agencies are also likely to meet Agency A's quality requirements. Therefore it may be that Agency A would welcome the opportunity to access Agency B's provider list in search of sellers and that Agency B could charge a service as the intermediary agency between the buyer who belongs to Agency A and the seller who belongs to Agency C.

In this embodiment, the screen illustrated in FIG. 15. is amended to include a further column headed “allow access to my provider list”. Selecting this option for any re-seller agency in the rows below allows a search by a buyer owned by that agency to then search sellers on the present agency's provider list at the same mark up as the agency itself has agreed. An additional column headed “intermediary charge” sets the sum (either percentage of seller rate or fixed charge) to be added to the agreed owning agency's rate as presented in column 1515. Agency Provider List 560 is amended to include fields for the storage of this information. Likewise, Agency Transaction Records 565 as shown in FIG. 12 is amended to include the following columns (a) intermediary agency (b) fee due to intermediary agency per unit sold.

In a further embodiment such arrangements can not be input unilaterally by an agency that wishes to act as intermediary. The negotiation process as exemplified by the screen represented in FIG. 8. has to be completed between potential intermediary agency and owning agency and then between potential intermediary agency and re-selling agency with the final arrangement and rate agreement having to be accepted by all three parties. The arrangement therefore appears on an additional column in the screen represented by FIG. 10a headed “search supplier agency's provider list?”

Once an agency is established as an intermediary the search by a buyer of an agency to whom they provide is amended, with reference to the process shown in FIGS. 11a and 11b, as follows. (a) step 1125 searches not only the provider agency's own list of sellers but works progressively through agencies on the provider agency's provider list until step 1135 is satisfied (b) step 1145 includes a check for the presence of an intermediary agency in the search process and includes the appropriate mark up for said agency if appropriate (c) step 1150 includes the storage of possible intermediary identity and intermediary fee (d) step 1155 is amended to include the intermediary fee as explained below.

In a further embodiment the re-selling agency can stipulate whether intermediary fees for any particular provider list are to be added to the client charge or deducted from the owning agency's mark-up on a sale. As already disclosed, the owning agency can additionally chose to have seller options that incur negative commission for the owning agency removed from the options displayed to a buyer. It will be clear that this embodiment would work well with the “most profitable” embodiment disclosed above. This would allow the owning agency to only offer sellers carrying the cost of an intermediary agency when absolutely necessary to maintain the number of sellers to be displayed.

In a further aspect of this embodiment the search performed at step 1125 in FIG. 11. may be amended so the search order becomes (a) sellers belonging directly to agencies on the owning agency's provider list who are searched in list order (b) sellers available on an intermediary agency basis, these would be searched in list order if the first step failed to produce the Target Number of sellers. Whichever order the search is constructed, step 1125 Agency Transaction module 535 must ensure a pool of sellers from an agency is only searched once even if the agency appears on both the owning agency's provider list and one or more of the provider lists of potential intermediary agencies.

It will be clear that willingness to act as an intermediary agency can be offered within an additional column on the screen represented by FIG. 7. Said column could be headed “will allow access to own provider list: Yes or No”. A further column would list the intermediary charge. Thus one agency who has built up a list of reputable agencies in their area is able to make that list available to a wider market and benefit from doing so.

### Provider Determined Prioritization Embodiment

An agency may not wish to act as a provider of last resort to other agencies. That is they will only supply to agencies who prioritize them above a chosen number on the re-selling agency's provider list. This embodiment would require an additional column within the screen represented by FIG. 7. Said column could be headed “prioritization required”. Assuming the number was 3 and an a potential re-seller accepted the provider agency on those terms the provider would automatically be inserted into the re-seller agency list at number 3. Any attempts to downgrade it, either (a) through the screen represented by FIG. 10b (b) by allowing automatic re-ranking of the list as additional agencies were added, would be blocked.

The following amendments would be required by this embodiment (a) Agency Provider List 560 requires an additional field to record “prioritization to be at least” (b) Partner Management Module 530 requires the ability to stop downgrading below said figure (c) the screen represented by FIG. 8, needs an additional field labelled “prioritization to be at least [X], said figure then being input into Agency Provider List 560 once both parties had signified their agreement on the screen (d) in FIG. 14. lines 1415 and 1420 would additionally read “subject to prioritization of at least [X] (e) FIG. 10a. would require a new column headed “prioritization must be at least [X]”.

### Advanced Price-Construction Embodiments

### Fixed Costs Embodiment

Some middlemen in a market define distinct costs which have to be paid on every transaction and negotiate split commissions separately. In many temporary work markets for instance immutable costs related to the worker such as tax and welfare payments are labeled “candidate costs” and become an additional factor in commission negotiations. The present invention could likewise allow agencies to define mixed costs” to be added onto every sale using a page generated by Agency Registration Module 510 and stored in Agency Datastore 545. What these costs include must be agreed between all users and could be embedded in a contract with agencies using the system. These costs, which can be a percentage of the seller unit price or a fixed fee per unit sold, are then calculated by Price Construction Module 425 for each transaction and become a distinct column in the payment record within Transaction Database 433.

### Percentage Split Embodiment

The screen shown in FIG. 7 can be amended at line 705 and line 710 to create an offering whereby a potential re-seller agency specifies a percentage split with a provider agency of the mark-up recorded against a buyer in Agency Buyer Record 555. As an example they may specify that they will accept any provider who will provide a seller in return for 40% of the mark-up charged to a buyer. Potential provider agencies would be able to define their willingness to accept these arrangements in a modified version of line 1415 and 1420 in FIG. 14. Such modifications will be obvious to one skilled in the art.

### “Most Profitable” Ordering Embodiment

An agency may wish to display sellers to an owned buyer prioritized according to the mark-up retained by the agency. To achieve this step 1155 in FIG. 11b is modified to add a column in FIG. 13 headed “mark-up retained by buyer owning agency”. Available sellers are then prioritized by the mark up figure per unit of sale that would be retained by the agency owning the buyer with the highest figure at the top of the list. Step 1160 in FIG. 11b then takes the Target Number or sellers for display from that list.

### Permissible Price Premium Embodiment

It is known that large buyers who have purchasing agreements with multiple middlemen in a market will typically demand a contract that specifies exactly the amount the middlemen may earn relative to the extent to which they sub-contract the buyer's requirements. This can be achieved in new ways using the present invention.

Agency Buyer Record 555 can include the stipulation that the agency owning the buyer is allowed a fixed percentage price premium over the average for a pool of sellers from approved sources returned by Assembly of Options Module 424. It might be for instance that the owning agency is allowed to charge no more than 20% premium for its sellers. This is achieved by (a) defining the appropriate Agency Provider List 560 so all sources are “Best Value” (b) at step 1155 in FIG. 11b calculating the arithmetic mean unit price of all available sellers (c) creating a further column in the table illustrated at FIG. 13 headed “allowable price” which transfers the full unit price of all sellers from other sources but transfers only 80% (in this example) of the price of sellers from the owning agency (d) prioritizing sellers by “allowable price”, cheapest on top (e) completing step 1160 as normal with the actual price being displayed.

### Variable Charge to Agencies Embodiment

In this embodiment Agency Datastore 545 as shown in FIG. 6a is expanded to include a record for “commission charged to agency by market operator”. The amount is input as part of the information gathered by Agency Registration Module 510. This mark-up, percentage of seller unit price or flat fee per unit, is added to all purchases by buyers owned by this agency and replaces the system default mark-up applied by Price Construction Module 425. It will be appreciated that the system operator may wish to vary the mark-up rate levied on transactions conducted by clients of a particular agency for a plurality of reasons.

### Per-Transaction Pricing

As an alternative to flat rate or percentage mark ups any component of the price construction could be replaced by a per completed transaction charge. This charge would be divided between the number of units in a sale at step 1145 in FIG. 11a to allow comparisons.

### Cross Sector Selling Embodiment

It will be appreciated that the kind of market described can be applied to multiple sectors. Agencies in one sector may wish to offer their buyers products from an agency in another sector adding their own commission. For example a temporary work agency offering sellers from an overnight accommodation sector in which a plurality of middlemen have pools of buyers and sellers. This is achieved by modifying the screen shown in FIG. 7 to include an option asking “in which sector do you wish to chose providers?” and offering a selection of every market sector offered by the system.

Similarly an agency needs to be able to define a rate at which it will provide to buyers owned by agencies in its own sector and buyers owned by agencies in other sectors. This is achieved by means of an additional line on the screens represented by FIG. 7 and FIG. 14 that allows the agency to stipulate the sectors to which their offer to potential providers or potential re-sellers applies.

### Variable Auto-Acceptance Embodiment

An agency can define on the screen illustrated in FIG. 7 or FIG. 10a, the characteristics of agencies to which it wants a plurality of offers to provide or re-sell displayed. The two screens would be amended to offer selections of characteristics which might include (a) geographic location (b) value of buyers registered (in terms of last 12 months sales or other timespan input through Service Provider Terminal 308) (c) number of sellers registered (d) percentage of business going through partner agencies (e) auto-accept rate offered to partners (f) value of business going through partners in a given timeframe (calculated as total business sold in that timeframe multiplied by percentage of business through partners in that timeframe).

Thus an agency is able to define a pool of agencies such as “agencies within 50 miles of my base with more than 200 sellers registered and turning over more than $500,000 a year in this system. The initiating agency can then define an auto accept rate specifically for other agencies within that pool. This is stored in an extended form of record 625 or 630 (depending on whether it is a re-sell offer or a provider offer) in Agency Datastore 545. That offer rate then over-rides the default offer rate. It will be appreciated that any agency could thus have a pool of such definitions with an auto offer rate attached to each. Where another agency appeared in more than one pool the offers would be listed and filtered to ensure the most beneficial rate for the recipient agency alone was offered.

### Reciprocality Enforcement Embodiment

An agency might wish to specify that it will allow another agency to re-sell its sellers but only if the rate at which this happens is reciprocal: the partner agency sells under the same terms. This is realized with an additional button on the screen represented by FIG. 8. It is labeled “ensure reciprocality” and is clearly labeled as having been selected at all points in the negotiation. Thus, any offer to be a provider by one agency to the other at an agreed rate automatically creates an identical entry on both agencies' Agency Provider List.

In a further embodiment of this invention the reciprocality extends to the prioritizing of the agencies on Agency Provider List 560 with both being inserted in the “Best Value” pool of the other by default. When one changes that prioritization the other is notified and asked if they wish to likewise re-order their list. Any change by either party is then notified to the other automatically through a message generated by Agency Negotiations Module 525.

### Partnering Limitation Embodiment

An agency's value as either provider or re-seller is increased if it is known that they undertake to limit the number of potential partner agencies with which they will do business. This voluntary undertaking might be set using an additional button on the screens shown in FIGS. 7 and 14 specifying for example “I will not provide to more than 10 agencies”. This commitment by any listed agency is then displayed in an additional column on these two screens. The agency is then prohibited by Partner management module 530 from exceeding that number without a negotiation process and acceptance from each existing partner.

### Fixed Term Partnering Embodiment

On the screens represented by FIGS. 7 and 14 an agency can indicate that it wishes to form a list that will only be active for a defined period. This might for instance be set up for four weeks by an agency supplying catering workers during a festival when many such workers will be required. The subsequent list becomes the Agency Provider List 560 for that time period which then reverts back to the previous default list.

### Graded Market Embodiment

It will be clear to those skilled in the art that the agency functions described and the graded market outlined in the underlying architecture section of this document can be combined to allow rules to be set that apply only to certain grades of sellers. On the screens represented by FIGS. 7 and 14 buttons would be offered that defined which grades the arrangements being made covered. Thus an agency could specify that it would only allow sellers from the higher grades from other agencies into its market for buyers.

### Agency/Branch Interchangeability Embodiment

By default the system allows deals between administrators at head office level of agencies. In an additional embodiment it allows arrangements at branch level. This is achieved by (a) on the screens represented by FIGS. 7 and 14 allowing the user to select “display by agency” or “display by branch” if they select the second option every entity recorded as a branch on Agency Datastore 545, specifically recorded within line 610 shown on FIG. 6a is offered (b) if the user is a head office administrator any arrangements apply to the Agency Provider List 560 across all branches of the agency, if the user is a branch administrator the resulting deals are applied only to the Agency Provider List of that branch (c) messages generated by Agency Negotiation Module 525 are sent to the named branch administrator not headquarters administrator (d) it will be appreciated that screens represented by FIG. 10a and FIG. 15 will need to be supplemented with a line allowing definition of the parameters of the various Agency Provider Lists list they are now able to display.

### Non Public Listed Agency Embodiment

Agencies may not wish to display the terms on which they will accept new providers or new re-sellers to be publicly known. Thus in one embodiment the information may be hidden although in all other respects the auto accept function works as previously described.

### Variable Negotiations Time Limits Embodiment

Some markets are particularly fast moving at certain times and the time set for Inter-agency communication might be unacceptable for these conditions. A modified version of the screen represented in FIG. 8 would allow the initiating user to define a period in which the offer will lapse. Obviously such a facility could not be made available to agencies wishing to change the parameters of their deal with a partner agency, such dialogues need a common timeframe to stop unscrupulous agencies withdrawing from agreements unilaterally.

### “Members Only Lists” Embodiment

In a further embodiment of the present invention a plurality of lists of agencies and pre-determined rates at which they will supply to fellow members of an organisation could be stored. Thus a new member of, for example, the Association of Residential Letting Agencies, could immediately access and install a provider list compiled by an administrator for said Association and exclusive to members. Said list would be accessible only on input of a password notified by the Association to members. The list could be exclusive—displacing the Agency's Provider List 560 and not open to additions or inclusive, allowing the agency to add additional providers in ways already disclosed.

This embodiment would require the following modifications to the technology outlined in this application. (a) Addition of new module to Agency Datastore 545 called “List Holder” this stores a plurality of said provider lists that are not attached to any agency plus at least one administrator name and password for a user authorised to firstly create then amend a particular list and secondly add to a list of users who are authorised to access said list. (b) FIG. 7 is amended to include a button saying “create list” and a second button saying “access list”. The first brings up a blank version of screen 10a with a box requiring the user to give the list a name and a second box headed “current authorised users”. The second brings up a display of all lists stored in List Holder within Agency Datastore 545, a user selects a list and is either granted access if they are on the list of authorized users or is invited to “request use of list” which sends a message to the administrator. (c) FIG. 10a is modified to display a list name where it is a members only list being accessed. Additionally it features a button called “insert list into my provider list”. This copies all entries across to the user's Agency Provider List 560, either inclusively (adding to existing agencies and using the better of two rates when an agency is on the member's list and the Agency Provider List) or exclusively, removing any existing entries. (d) list administrators can be created independently of any agency using Service Provider Terminal 308 using screens for the creation of agency staff, administrators are stored within Agency Datastore 545 under a new section headed “List Administrators”.

In a further embodiment members-only lists could automatically update any Agency Provider Lists in which they have been installed as new members are added or rates for members changed. This would be achieved by Agency Provider List 560 checking installed list or lists for amendments at the start of each user session or as triggered by changes.

### Agency Removal Embodiment

It will be clear that on occasions an agency will have to be removed from the system either for illegal behaviour or because the entity ceases to trade. It is in the interests of said Agency's buyers and sellers that they be found alternative accommodation within the system. In a preferred embodiment, said individuals will already be registered in Seller Database 431 or Buyer Database 432 and can revert to being non-owned buyers or sellers with no agency relationship. Only their records within Agency Seller Records 550 or Agency Buyer Records 555 cease to function.

In an alternative embodiment users owned by an agency that was about to cease operation on the system could be automatically referred to other agencies and can then select which they wish to be owned by in the future. Acceptance would be subject to agency authorisation through a dedicated page. Referral would be based on either (a) proximity of agency postcode (b) highest number of transactions in the user's most frequently transacted market (c) some weighted combination of the two. Ideally said users would be offered a list of perhaps three such agencies from which to chose. Such referrals could be part of the system's contract with agencies.

### Display of Options Embodiments

### Prioritized Display Embodiment

It will be appreciated that, although Agency A is willing to display other agencies' sellers to Agency A's buyers, Agency A may wish to encourage purchase of its own sellers from the resulting list. This can be achieved by distorting the list of option on the screen shown in FIG. 2 which displays the list of available sellers for a particular transaction. In one embodiment of this functionality the screen represented by FIG. 10a which allows an agency to manage their provider partner agencies is amended to include a “highlight options down to level X on the list” selection. Thus if level 2 is selected all sellers from the top two agencies are displayed in large boxes or more eye catching colours or highlighted in some way on the screen shown in FIG. 2. The sellers to be thus highlighted may be marked as such in a further embodiment of step 1155 shown on FIG. 11b. In a further embodiment of this function there could be levels of display defined for example “display sellers from agencies down to level 2 on my prioritized list at maximum size”, “display sellers from further agencies down to level 5 on my prioritized list at large size”, “display sellers from further agencies down to level 8 on my prioritized list at mid size” and so on. Thus a scale of highlighted seller returns is offered to a buyer.

### Short Term Alert Embodiment

It will be appreciated that a buyer owned by Agency A may at any time place a large order for sellers which the prioritized list as shown in FIG. 10a for Agency A is inadequate to supply. There is therefore a need for a means by which Agency A can immediately and automatically expand its prioritized list at times of sudden need for more provider agencies.

In a preferred embodiment Agency A is able to access an additional button on the screen represented by FIG. 10 which allows them to select “if buyer purchases X % of sellers available I will extend my provider list for that transaction to all auto-accept providers who require less than Y % for the duration of that transaction”. Thus, if a buyer wishes to buy nearly all, all, or more than, the number of sellers that are readily available through the existing provider arrangements the list can immediately be expanded to include agencies offering less favorable terms. This is stored as a secondary version of Agency Provider List 560.

I will illustrate this with an exemplary transaction. Agency A have specified that once one of their buyers have clicked on more than 75% of sellers available on the screen shown on FIG. 2 and indicated that they wish to buy more but will not buy those remaining on the screen then a new list of sellers will be found by extending the range of agencies Agency A will accept as providers from those charging less than 12% to those charging less than 15%. Thus, a buyer owned by Agency A who has selected and purchased 75% or more of the sellers on Screen 2 is asked if he wishes to buy further sellers. If he selects Yes” the following occurs. (a) a distinct Agency Provider List 560 is created and labeled with the unique identifier code for this transaction, it auto accepts all providers on the database who will accept a rate of less than 15% and are not already on the Agency Provider List previously being used for this transaction, instructions regarding commission construction are applied as they were in the Agency Provider List used in the transaction which allowed the buyer to purchase on the first version of the screen shown in FIG. 2 that he was offered (b) the search and pricing process as described in FIG. 11a and 11b is triggered with the new Agency Provider List just described located at step 1120 (c) the results are displayed on a fresh screen to the buyer (d) the Agency Provider List is stored in Agency Transaction Records 565 against this transaction.

It will be immediately obvious that there could be any number of increments in the above process. For instance, accepting provider agencies who will auto accept at up to 15% to create a further screen and then if the buyer still wishes to purchase more sellers accepting those who charge up to 18% and so on. Likewise such secondary lists can be invoked at step 1135 of the FIG. 11a if the number of returns is below a number selected by the agency once the prioritized list has been exhausted.

In above described embodiments of the system the Internet, and more specifically web technology, is used for communication between a central computer system and the buyers and sellers. However, it is not necessary to implement the invention using the Internet and the system may, for example, be implemented on local or wide area networks, wireless mobile communications networks, cable TV networks and the like. Similarly, the terminals used by the buyers and sellers for communicating with the central computer system may comprise mobile phone handsets, personal digital assistants, inter-active televisions and the like. Likewise, as it is well known to those skilled in the art, the processing for performing the functions described above may be shared between machines in ways other than that shown in the illustrated embodiments. No doubt many other effective alternatives will occur to the skilled person and it will be understood that the invention is not limited to the described embodiments and encompasses modifications apparent to those skilled in the art lying within the spirit and scope of the claims appended hereto.

1.-60. (canceled)

61. A transaction management system for managing the purchase of an item and/or service by a buyer from a seller, wherein at least some sellers are associated with agencies, the system comprising:
a plurality of agency data stores, each for storing agency data comprising:
seller data for each of a plurality of sellers associated with the agency; and
indication data for indicating whether the agency is prepared to offer sellers associated with the agency to buyers associated with other agencies and the terms of any such offer;
a program store storing processor implementable instructions; and
a processor coupled to the agency data store and to the program store for implementing the stored instructions; wherein the stored instructions comprise instructions for controlling the processor to:
implement a buyer interface to receive a purchase inquiry from a buyer;
output seller offer data to the buyer for a plurality of sellers, wherein the seller offer data presented to the buyer takes into account the terms of said offer of sellers associated with an agency to buyers associated with other agencies;
receive a purchase request from the buyer accepting a said offer; and
implement a seller interface to output the purchase request to the identified seller for requesting purchase of a service or item; and ascertain compliance data for determining whether the identified seller is willing or able to comply with the buyer purchase request.

62. A system as claimed in claim 1, wherein the purchase request comprises request data indicating a service or item of commerce requested by the buyer.

63. A system as claimed in claim 1, further comprising means for storing seller data comprising, for each of a plurality of sellers not associated with any agency, a seller identifier and seller offer data indicating at least one service or item of commerce offered for sale.

64. A system as claimed in claim 1, wherein, for a seller offering services for sale, the seller data in the general data store further comprises an availability diary for the seller.

65. A system as claimed in claim 1, wherein the stored instructions comprise instructions for controlling the processor to:
output seller offer data from the agency with which the buyer is associated; and
output seller offer data from other agencies when the agency with which the buyer is associated accepts the terms of the offer of seller from the other agencies.

66. A system as claimed in claim 1, wherein the stored instructions comprise instructions for controlling the processor to output seller offer data from other agencies only when insufficient offers are available from the agency with which the buyer is associated.

67. A system as claimed in claim 1, wherein the stored instructions comprise instructions for controlling the processor to output seller offer data in an order based on factors including a ranking given to the other agencies.

68. A system as claimed in claim 1, wherein the processor comprises means for calculating the price by adding to the seller price, the commission of the agency with which the buyer is associated, a part of this commission being paid to the agency with which the seller is associated under the terms of the offer from the agency with which the seller is associated to the agency with which the buyer is associated.

69. A system as claimed in claim 1, further comprising means for calculating the price and determining if the commission to be paid to the agency with which the seller is associated is greater than commission of the agency with which the buyer is associated, and if so removing the offer from the seller offer data.

70. A system as claimed in claim 1, wherein the stored instructions comprise a software module for allowing negotiation between agencies of the terms under which sellers associated with one agency are offered to buyers associated with the other agency.

71. A system as claimed in claim 1, wherein the stored instructions comprise a software module for automatic acceptance of terms under which sellers associated with one agency are offered to buyers associated with the other agency, when these terms meet predetermined criteria.

72. A system as claimed in claim 1, further comprising means for determining payments between agencies when a seller transfers between the agencies.

73. A system as claimed in claim 1, further comprising means for determining the division of commission payments between a plurality of agencies with which a buyer or a seller is associated.

74. A system as claimed in claim 1, wherein the agency data store further comprises data relating to agreements between three or more agencies in which one agency acts as intermediary between two others.

75. A method for managing the purchase of an item and/or service by a buyer from a seller, wherein at least some sellers are associated with agencies, the method comprising:
storing in an agency data store seller data for each of a plurality of sellers associated with the agency, and indication data for indicating whether the agency is prepared to offer sellers associated with the agency to buyers associated with other agencies and the terms of any such offer;
implementing a buyer interface for receiving a purchase inquiry from a buyer;
outputting seller offer data to the buyer for a plurality of sellers, wherein the seller offer data presented to the buyer takes into account the terms of said offer of sellers associated with an agency to buyers associated with other agencies;
receiving a purchase request from the buyer accepting a said offer;
implementing a seller interface to output the purchase request to the identified seller for requesting purchase of a service or item; and
ascertaining compliance data for determining whether the identified seller is willing or able to comply with the buyer purchase request.

76. A method claimed in claim 15, wherein the purchase request comprises request data indicating a service or item of commerce requested by the buyer.

77. A method as claimed in claim 15, further comprising:
storing seller data comprising, for each of a plurality of sellers not associated with any agency, a seller identifier and seller offer data indicating at least one service or item of commerce offered for sale.

78. A method as claimed in claim 15, further comprising:
storing seller data comprising, for each of a plurality of sellers associated with another agency, a seller identifier, seller offer data indicating at least one service or item of commerce offered for sale, and data indicating the agency with which the seller is associated.

79. A method as claimed in claim 15, further comprising:
storing buyer data identifying, for each of a plurality of buyers associated with an agency, data indicating the agency with which the buyer is associated.

80. A method as claimed in claim 15, further comprising, for a seller offering services for sale, creating an availability diary for the seller.

81. A method as claimed in any one of claim 15, further comprising generating historical data relating to the previous seller performance in response to purchase requests associated with the seller.

82. A method as claimed in claim 15, wherein the seller offer data is output to the buyer, and the acceptance of a purchase request is received from the buyer, without reference to the seller.

83. A method as claimed in claim 15, wherein outputting seller offer data comprises:
outputting seller offer data from the agency with which the buyer is associated; and
outputting seller offer data from other agencies when the agency with which the buyer is associated accepts the terms of the offer of seller from the other agencies.

84. A method as claimed in claim 15, wherein outputting seller offer data from other agencies is carried out only when insufficient offers are available from the agency with which the buyer is associated.

85. A method as claimed in claim 15, wherein outputting seller offer data comprises generating a list in an order based on factors including a ranking given to the other agencies.

86. A method as claimed in claim 15, further comprising determining if the commission to be paid to the agency with which the seller is associated is greater than commission of the agency with which the buyer is associated, and if so removing the offer from the seller offer data.

87. A method as claimed in claim 15, further comprising determining payments between agencies when a seller transfers between the agencies.

88. A buyer terminal for a buyer to remotely purchase a service or item from a seller via an intermediary system, the buyer being associated with an agency, the terminal comprising:
a data memory operable to store data to be processed;
a program store for storing processor implementable instructions;
a communications interface for receiving data from and transmitting data to the intermediary system; and
a processor, coupled to the data memory and to the program store for implementing the stored instructions, and to the communications interface for receiving and storing instructions for the processor in the program store;
and wherein, in use, the program store stores instructions for controlling the processor to:
implement a buyer interface to receive a purchase inquiry from a buyer;
receive seller data comprising, for each of a plurality of sellers, seller offer data indicating at least one service or item of commerce offered for sale relating to the purchase inquiry, the seller offer data presented to the buyer including sellers associated with other agencies and taking into account the terms under which said other agencies offer their sellers to the agency with which the buyer is associated;
generate a user interface to output said seller offer data and to receive a purchase request from the buyer accepting a said offer; and
transmit the purchase request to the intermediary system.

89. A method for using a buyer terminal to remotely purchase a service or item from a seller via an intermediary system, the buyer being associated with an agency, the method comprising:
using the buyer terminal to make a purchase inquiry;
receiving seller data comprising, for each of a plurality of sellers, seller offer data indicating at least one service or item of commerce offered for sale relating to the purchase inquiry;
generating a user interface to output said seller offer data and receive a purchase request from the buyer accepting a said offer, the seller offer data presented to the buyer including sellers associated with other agencies and taking into account the terms under which said other agencies offer their sellers to the agency with which the buyer is associated; and
transmitting the purchase request to the intermediary system.

90. A method of supplying goods and/or services from a buyer to a seller via an intermediary, the method comprising:
logging details of goods/services on offer from a plurality of sellers;
recording which sellers are associated with agencies;
recording which buyers are associated with agencies;
recording which agencies are prepared to offer sellers associated with the agency to buyers associated with other agencies and the terms of any such offers;
receiving a purchase inquiry from a buyer;
presenting seller offer data to the buyer which takes into account the terms of any said offers;
receiving a purchase request from the buyer accepting a said offer;
providing the purchase request to the identified seller; and
ascertaining compliance data for determining whether the identified seller is willing or able to comply with the buyer purchase request.
